(19) United States
(12) Patent Application Publication
(10) Pub. No.: US 2015/0088554 A1
(43) Pub. Date: Mar. 26, 2015

(54) Methods, Systems, and Servers for Processing Health Insurance Claims

(71) Applicant: Argus Health Systems, Inc., Kansas City, MO (US)

(72) Inventors: Roderick J. McKinney, Kansas City, MO (US); Melinda Bossert, Kansas City, MO (US); Laurie Plotch, Phoenix, AZ (US)

(73) Assignee: Argus Health Systems, Inc., Kansas City, MO (US)

(21) Appl. No.: 14/034,976

(22) Filed: Sep. 24, 2013

(51) Int. Cl. G06Q 30/02

(52) U.S. Cl. CPC G06Q 30/0238; G06Q 40/08
USPC 705/4

(57) ABSTRACT

Methods of processing applications for compensation include: (a) receiving an application for compensation submitted to a processing hub through a point of sale and/or a system coupled therewith; (b) evaluating the application for compensation in response to the receiving based on data associated with a consumer and/or the application for compensation and/or the point of sale; (c) determining a dispositive outcome for the application for compensation; and (d) implementing the dispositive outcome at the point of sale. Systems and servers for processing applications for compensation, and computer-readable storage media containing instructions for processing applications for compensation, are described.

### TECHNICAL FIELD

The present teachings relate generally to the processing of applications for compensation and, in some embodiments, to the processing of insurance claims.

### BACKGROUND

Providers of certain goods and services (e.g., health-care providers, such as pharmacies) can seek partial and/or full reimbursement for the costs of their goods and services from another entity (e.g., an insurance company or an affiliate thereof) at or around the time the goods or services are provided to a recipient thereof (e.g., a consumer or beneficiary). By way of example, when an individual presents a prescription for a drug at a pharmacy, the pharmacy can contact the individual's insurance company or an affiliate thereof at the point of sale to determine the extent to which the cost of the drug is reimbursable, and whether the individual is responsible for any portion of this cost (e.g., through a co-pay).

With the costs of health-care continuously increasing, it is highly advantageous—to both insurance companies and consumers—to encourage individuals to make healthier decisions, comply with physician recommendations, adhere to prescribed treatment regimens, and, in general, take more personal responsibility for looking after their own health. A mechanism for rewarding consumers in real time at points of sale for exhibiting such desired behavior is desirable.

### SUMMARY

The scope of the present invention is defined solely by the appended claims, and is not affected to any degree by the statements within this summary.

By way of introduction, a computer-implemented method of processing a health insurance claim in accordance with the present teachings includes: (a) receiving, by a processor, a health insurance claim submitted to an insurance claims processing system by and/or on behalf of a consumer through a point of sale and/or a system coupled therewith; (b) identifying, by the processor, the health insurance claim as being eligible for rewards-based processing; (c) evaluating, by the processor, the health insurance claim in response to the receiving based on data associated with the consumer and/or the health insurance claim and/or the point of sale; (d) determining, by the processor, a dispositive outcome for the health insurance claim, wherein the dispositive outcome includes rewarding the consumer for exhibiting a desired behavior; and (e) implementing, by the processor, the dispositive outcome at the point of sale. The consumer has a disease state, and the desired behavior includes monitoring the disease state.

A first system for processing a health insurance claim in accordance with the present teachings includes: (a) a processor; (b) a non-transitory memory coupled to the processor; (c) first logic stored in the memory and executable by the processor to cause the processor to receive a health insurance claim submitted to an insurance claims processing system by and/or on behalf of a consumer through a point of sale and/or a system coupled therewith; (d) second logic stored in the memory and executable by the processor to cause the processor to identify the health insurance claim as being eligible for rewards-based processing; (e) third logic stored in the memory and executable by the processor to cause the processor to evaluate the health insurance claim responsive to receipt thereof based on data associated with the consumer and/or the health insurance claim and/or the point of sale; (f) fourth logic stored in the memory and executable by the processor to cause the processor to determine a dispositive outcome for the health insurance claim, wherein the dispositive outcome includes rewarding the consumer for exhibiting a desired behavior; and (g) fifth logic stored in the memory and executable by the processor to cause the processor to implement the dispositive outcome at the point of sale. The consumer has a disease state, and the desired behavior includes monitoring the disease state.

A second system for processing a health insurance claim in accordance with the present teachings includes: (a) means for receiving an insurance claim submitted to an insurance claims processing system by and/or on behalf of a consumer through a point of sale and/or a system coupled therewith; (b) means for identifying the health insurance claim as being eligible for rewards-based processing; (c) means for evaluating the health insurance claim responsive to receipt thereof based on data associated with the consumer and/or the health insurance claim and/or the point of sale; (d) means for determining a dispositive outcome for the health insurance claim, wherein the dispositive outcome includes rewarding the consumer for exhibiting a desired behavior; and (e) means for implementing the dispositive outcome at the point of sale. The consumer has a disease state, and the desired behavior includes monitoring the disease state.

A non-transitory computer readable storage medium in accordance with the present teachings has stored therein data representing instructions executable by a programmed processor for processing a health insurance claim. The storage medium includes instructions for: (a) receiving a health insurance claim submitted to an insurance claims processing system by and/or on behalf of a consumer through a point of sale and/or a system coupled therewith; (b) identifying the health insurance claim as being eligible for rewards-based processing; (c) evaluating the health insurance claim in response to the receiving based on data associated with the consumer and/or the health insurance claim and/or the point of sale; (d) determining a dispositive outcome for the health insurance claim, wherein the dispositive outcome includes rewarding the consumer for exhibiting a desired behavior; and (e) implementing the dispositive outcome at the point of sale. The consumer has a disease state, and the desired behavior includes monitoring the disease state.

### BRIEF DESCRIPTION OF THE DRAWINGS

FIG. 1 shows a flow chart depicting a first exemplary method of processing an application for compensation in accordance with the present teachings.

FIG. 2 shows a flow chart depicting a second exemplary method of processing an application for compensation in accordance with the present teachings.

FIG. 3 shows a block diagram of an exemplary implementation of a system for processing applications for compensation in accordance with the present teachings.

FIG. 4 shows an illustrative embodiment of an exemplary general computer system for use with the system of FIG. 3.

FIG. 5 shows an illustrative embodiment of an exemplary event-based management processing workflow.

The Appendix placed at the end of the specification and forming a part hereof shows exemplary implementation details in accordance with the present teachings.

### DETAILED DESCRIPTION

Methods and systems for processing applications for compensation—including but not limited to insurance claims—in which a user can be incentivized to exhibit one or more desired behaviors have been discovered and are described herein. As further described below, rewards-based methods for processing applications for compensation in accordance with the present teachings may, in some embodiments, be integrated into an insurance claims processing system (and/or used to supplement an extant insurance claims processing system). Throughout this specification and in the appended drawings, methods for processing applications for compensation in accordance with the present teachings are sometimes referred to as event-based management (EBM).

It is to be understood that elements and features of the various representative embodiments described below may be combined in different ways to produce new embodiments that likewise fall within the scope of the present teachings.

By way of general introduction, a method of processing an application for compensation in accordance with the present teachings comprises: (a) receiving an application for compensation submitted to a processing hub through a point of sale and/or a system coupled therewith; (b) evaluating the application for compensation in response to the receiving based on data associated with a consumer and/or the application for compensation and/or the point of sale; (c) determining a dispositive outcome for the application for compensation; and (d) implementing the dispositive outcome at the point of sale.

In some embodiments, a method in accordance with the present teachings further includes (e) identifying the application for compensation as being eligible for dispositive outcome-based processing (e.g., in some embodiments, rewards-based processing). In some embodiments, a method in accordance with the present teachings further includes (f) receiving data provided by the consumer at the point of sale. In some embodiments, a method in accordance with the present teachings further includes (g) accessing data from a database coupled to the processor.

In some embodiments, a method of processing an application for compensation in accordance with the present teachings is implemented using a computer and, in some embodiments, one or a plurality of the acts of (a) receiving, (b) evaluating, (c) determining, (d) implementing, (e) identifying, (f) receiving data, and/or (g) accessing described above are performed by one or a plurality of processors. In some embodiments, the processing hub acts as a centralized claims processing system which, as implemented by a computer, is configured to receive multiple applications for compensation from multiple points of sale, and to perform the evaluating, determining, and implementing for each of the received applications for compensation. This centralized configuration provides data processing efficiency.

In some embodiments, the application for compensation is submitted to the processing hub by and/or on behalf of a user (e.g., a consumer). As used herein, the phrase “application for compensation” refers broadly to a request for something—particularly though not exclusively money—that is regarded as being an equivalent and/or a satisfactory and/or a fair recompense for goods or services provided in exchange (e.g., by and/or on behalf of a requesting entity). In some embodiments, an application for compensation is made by a requesting entity on behalf of another entity (e.g., a consumer), whereas in some embodiments, a single entity (e.g., a consumer) makes the application for compensation directly (e.g., the requesting entity and the consumer are one and the same).

In some embodiments, an application for compensation comprises an insurance claim and, in some embodiments, the processing hub comprises an insurance claims processing system. In some embodiments, the processing hub is operated by an insurance company and/or an affiliate thereof, such as a business process outsourcing company. Insurance claims from all manner of different types of insurance are contemplated for use in accordance with the present teachings. In some embodiments, the application for compensation comprises an insurance claim and the desired behavior of a consumer to be rewarded in accordance with the present teachings comprises any behavior that mitigates the risk of an insurance claim being filed and/or any behavior that reduces the cost to the insurance company, the consumer, and/or other associated entity as a result of a claim being filed.

By way of illustration, representative types of insurance for use in accordance with the present teachings include but are not limited to: accident insurance, agricultural insurance, alien abduction insurance, assumption reinsurance, aviation insurance, bancassurance, bond insurance, builder's risk insurance, business interruption insurance, business overhead expense disability insurance, casualty insurance, catastrophe bond, chargeback insurance, computer insurance, contents insurance, credit insurance, crime insurance, death bond, dental insurance, deposit insurance, directors and officers liability insurance, disability insurance, dual trigger insurance, earthquake insurance, expatriate insurance, fidelity bond, financial reinsurance, FLEXA (Fire Lightning Explosion Aircraft), flood insurance, gap insurance, general insurance, German statutory accident insurance, group insurance, guaranteed asset protection insurance, health insurance, home insurance, income protection insurance, inland marine insurance, interest rate insurance, key person insurance, kidnap and ransom insurance, labor insurance (Japan), landlords insurance, legal expenses insurance, lenders mortgage insurance, liability insurance, life insurance, longevity bond, longevity insurance, marine insurance, mortgage insurance, mutual insurance, no-fault insurance, orthodontic insurance, parametric insurance, payment protection insurance, pension term assurance, perpetual insurance, pet insurance, political risk insurance, pollution insurance, pre-paid legal services, prize indemnity insurance, professional liability insurance, property insurance, protection and indemnity insurance, reinsurance, rent guarantee insurance, satellite insurance, tenancy deposit scheme (England and Wales), tenancy deposit schemes (Scotland), terminal illness insurance, terrorism insurance, trade credit insurance, travel insurance, UCC insurance, uninsured employer, workers' compensation employer defense, vehicle insurance, full tort and limited tort automobile insurance, motorist coverage in Pennsylvania, wage insurance, war risk insurance, weather insurance, worker's compensation (Germany), workers' accident compensation insurance (Japan), zombie fund, and the like, and combinations thereof.

In some embodiments, the application for compensation to be processed in accordance with the present teachings comprises a type of motorist insurance. In some embodiments, a representative type of desired behavior to be rewarded comprises a pattern of safe driving by the motorist (e.g., as determined from historical data about the motorist stored in a database and/or from data collected on an ongoing basis via an electronic monitoring device stored in the motorist's vehicle). In some embodiments, the application for compensation to be processed in accordance with the present teachings comprises a type of vehicle insurance. In some embodiments, a representative type of desired behavior to be rewarded comprises performing preventative maintenance on the vehicle, having maintenance and/or repairs performed on the vehicle by a specific dealership or other independent mechanic, etc.).

In some embodiments, the application for compensation to be processed in accordance with the present teachings comprises a health insurance claim. In some embodiments, particularly though not exclusively embodiments in which the application for compensation comprises a health insurance claim, the point of sale through which the application for compensation is submitted can be located within a health care provider. Representative health care providers in which the point of sale can be located include but are not limited to a pharmacy, a physician, a hospital, a clinic, a medical supply company, and combinations thereof, as well as any affiliates of one or more thereof.

In some embodiments, the evaluating of the application for compensation begins substantially proximately, such as immediately, upon receipt of the application—or at least within technological limits imposed by the speed of the intervening processing components and/or wired and/or wireless communication between the processing hub, the point of sale, and/or the consumer. In some embodiments, the evaluating begins substantially contemporaneously with (a) the presentation by a consumer of an application for compensation at a point of sale, (b) the submission of the application for compensation to a processing hub through the point of sale, and/or (c) the receipt of the application for compensation by the processing hub. For embodiments in which processing begins in response to the receipt of the application, such processing may be considered to be occurring in “real time.” It is to be understood that the amount of time that elapses between the presentation of the application for compensation by and/or on behalf of the consumer and the time a dispositive outcome is implemented at the point of sale is not restricted and may vary in accordance with the perception and/or expectations of a particular entity participating in and/or processing a given transaction. For embodiments in which the processing occurs, or is perceived to occur, within the expectations of a particular participating entity, such processing may be considered to be occurring in “real time” with respect thereto.

In some embodiments, a method in accordance with the present teachings further includes prioritizing an application for compensation. In some embodiments, the application for compensation is labeled with a priority indication that conveys a sense of an acceptable response time in which for the processing hub to determine and/or implement a dispositive outcome. In some embodiments, such acceptable response times may be defined via a Service Level Agreement (“SLA”) between the operator of a processing hub and an additional entity (e.g., point of sale, such as a pharmacy; insurance provider; etc.). By way of a non-limiting and representative example, an application for compensation for a prescription drug can be flagged to indicate high priority when a customer submitting the prescription is present at the pharmacy and has elected to wait to retrieve the prescription. By way of a further non-limiting and representative example, an application for compensation for a prescription drug can be flagged to indicate low priority when a customer submitted a request for the prescription remotely (e.g., via telephone, smartphone app, Internet, etc.) and has indicated that the prescription will not be physically retrieved until a later time. In some embodiments, a processing hub may decide to process applications for compensation having priority indications at or below a predetermined threshold level after first processing applications for compensation having priority indications at or above a predetermined threshold level (e.g., in order to increase processing efficiency, reduce processing backlogs, increase response times for higher priority applications, etc.).

In some embodiments, one or both of (a) the period of time between the receiving of an application for compensation by a processing hub and the determining of a dispositive outcome, and (b) the period of time between the determining of a dispositive outcome and the implementing of the dispositive outcome at the point of sale independently comprises less than about 24 hours, in some embodiments less than about 22 hours, in some embodiments less than about 20 hours, in some embodiments less than about 16 hours, in some embodiments less than about 12 hours, in some embodiments less than about 10 hours, in some embodiments less than about 8 hours, in some embodiments less than about 6 hours, in some embodiments less than about 4 hours, in some embodiments less than about 2 hours, in some embodiments less than about 90 minutes, in some embodiments less than about 60 minutes, in some embodiments less than about 45 minutes, in some embodiments less than about 30 minutes, in some embodiments less than about 25 minutes, in some embodiments less than about 20 minutes, in some embodiments less than about 15 minutes, in some embodiments less than about 12 minutes, in some embodiments less than about 10 minutes, in some embodiments less than about 8 minutes, in some embodiments less than about 6 minutes, in some embodiments less than about 5 minutes, in some embodiments less than about 4 minutes, in some embodiments less than about 3 minutes, in some embodiments less than about 2 minutes, in some embodiments less than about 90 seconds, in some embodiments less than about 60 seconds, in some embodiments less than about 45 seconds, in some embodiments less than about 30 seconds, in some embodiments less than about 25 seconds, in some embodiments less than about 20 seconds, in some embodiments less than about 15 seconds, in some embodiments less than about 10 seconds, in some embodiments less than about 8 seconds, in some embodiments less than about 5 seconds, in some embodiments less than about 3 seconds, in some embodiments less than about 2 seconds, and in some embodiments less than about 1 second.

In some embodiments, the data used in evaluating an application for compensation in accordance with the present teachings are selected from the group consisting of internal information stored by and/or on behalf of the processing hub, external information provided at the point of sale, and a combination thereof. In some embodiments, the internal information comprises information stored in an eligibility file (e.g., a file associated with a particular entity that contains information specific thereto). In some embodiments, the internal information is selected from the group consisting of insurance claims history (e.g., type, quantity, underlying causation, and/or frequency of prior claim submissions; etc.), demographics (e.g., state or region in which present or past insurance claim is/was submitted; etc.), consumer behavior (e.g., survey completion, wireless communication, communication preferences, etc.), and combinations thereof. In some embodiments, the external information is transmitted to the processor from the point of sale. In some embodiments, the external information comprises evidence that the consumer has exhibited the desired behavior. In some embodiments, the information used in determining the dispositive outcome comprises a combination of (1) historical information about a consumer and/or the consumer's claims history that is already stored (e.g., by the processing hub in a database) and (2) new information about the consumer obtained at the point of sale.

In some embodiments, the data used in evaluating an application for compensation in accordance with the present teachings comprises stateful (e.g., intra-transactional) information. As used herein, the term “stateful” refers to a transaction that depends upon or is a function of a prior transaction (e.g., utilizing historical information maintained across a plurality of discrete transactions). In some embodiments, the data used in evaluating an application for compensation in accordance with the present teachings comprises stateless (e.g., inter-transactional) information. As used herein, the term “stateless” refers to a transaction that does not depend upon, or is not a function of, a prior transaction.

In some embodiments, the consumer has a disease state that is controllable through behavior modification. The type of disease state to be controlled in accordance with the present teachings is not restricted and all manner of disease states are contemplated for use. By way of non-limiting example, representative disease states include but are not limited to hypertension, diabetes, heart disease, high cholesterol, obesity, addictions (e.g., nicotine, drugs, alcohol, etc.), mental disorders (e.g., depression, schizophrenia, etc.), cancer, stroke, orthopedic injuries, dental problems (e.g., gingivitis, decay, etc.), and the like, and combinations thereof.

In some embodiments, the dispositive outcome comprises rewarding the consumer for exhibiting a desired behavior. In some embodiments, the dispositive outcome comprises penalizing the consumer for not exhibiting a desired behavior. In some embodiments, the dispositive outcome comprises a combination of rewarding the consumer for exhibiting a desired first behavior and penalizing the consumer for not exhibiting a desired second behavior.

In some embodiments, the dispositive outcome comprises rewarding the consumer for exhibiting a desired behavior. In some embodiments, the rewarding comprises providing something to a consumer (e.g., coupons, store credits, reduced and/or waived co-pays, etc.) that is regarded by that particular consumer as being of value. In some embodiments, the rewarding may vary based on consumer, context, and/or perception, such that what is considered as constituting a reward (e.g., something of value) by one entity may not be similarly regarded as constituting a reward (or a sufficient reward) by a different entity. Thus, in some embodiments, the reward may vary depending upon the circumstances and/or entities involved in order to be meaningful and to elicit the desired consumer behavior. In some embodiments, different consumers may receive different rewards for having exhibited substantially identical desired behaviors. As a non-limiting and representative example, the rewarding of a first consumer who is typically responsible for paying a $20 co-pay to fill a prescription at a pharmacy might be to reduce the first consumer's co-pay to $10, whereas the rewarding of a second consumer who is typically responsible for paying a $10 co-pay to fill a prescription might be to waive the second consumer's co-pay entirely, even though the desired behaviors exhibited by each of the first consumer and the second consumer were substantially identical.

In some embodiments, the dispositive outcome comprises penalizing the consumer for not exhibiting a desired behavior. In some embodiments, the penalizing comprises withholding an incentive (e.g., requiring a consumer to pay the customary co-pay as opposed to a reduced co-pay for filling a prescription). In some embodiments, the penalizing comprises establishing a punitive increase in a consumer's financial obligation (e.g., increasing the amount of a consumer's customary co-pay).

In some embodiments, the rewarding of the consumer is contingent on the consumer exhibiting a first desired behavior (e.g., filling a prescription, filling a prescription at regular and/or prescribed intervals, etc.) in combination with one or more additional desired behaviors (e.g., seeing a physician, seeing a physician at regular and/or prescribed intervals, etc.). In some embodiments, the rewarding of the consumer is contingent on the consumer exhibiting a pattern of multiple instances of a desired behavior (e.g., filling a prescription a certain number of times, filling a prescription at regular and/or prescribed intervals, etc.).

In some embodiments, rewarding a consumer for exhibiting a desired behavior in accordance with the present teachings comprises reducing and/or waiving a co-pay required of the consumer (e.g., the consumer is given an economic incentive to exhibit a desired behavior). In some embodiments, the rewarding is based on the consumer having exhibited a pattern of one or more desired behaviors (e.g., as opposed to a single occurrence of a desired behavior), such that for each instance of the desired behavior, the consumer advances towards that point at which a reward is administered. By way of non-limiting and representative example, in some embodiments, the dispositive outcome comprises adjusting a value of awards points credited to the consumer (e.g., wherein a minimum value of awards points are required for a reward to be issued). As used herein, the term “awards point” refers broadly and without limitation to any quantifiable unit of measure that can be used to track the status of a consumer's status and/or eligibility for a reward (and/or penalty), including but not limited to tallies, integers, non-integers, percentages, fractions, and the like, and combinations thereof. Thus, in some embodiments, the rewarding is deferred until the value (e.g., number) of awards points meets or exceeds a threshold.

In some embodiments, the rewarding is based on the consumer having satisfied a predetermined minimum subset of required criteria. By way of representative and non-limiting example, in some embodiments, a consumer who has satisfied 3 or more out of 5 pre-established criteria may be determined to be eligible for a reward in accordance with the present teachings. In some embodiments, the rewarding is based on the consumer having satisfied all of a set of required criteria (e.g., an imperfect subset).

In some embodiments, the dispositive outcome comprises tagging the application for compensation and/or identifying information associated with the consumer who submitted the application for compensation (or caused it to be submitted on the consumer's behalf) in accordance with a business rule. In some embodiments, the application for compensation and/or identifying information associated with the consumer who submitted the application for compensation are tagged with multiple tags, which may be the same or different. In some embodiments, the business rule is selected from the group consisting of drug-related criteria, pharmacy-related criteria, prescriber-related criteria, consumer-related criteria, claim-related criteria, and combinations thereof. Once a tag is in place (e.g., on the particular application for compensation or in association with a particular consumer), it can be used as a criterion for additional EBM in accordance with the present teachings. By way of non-limiting and representative example, a consumer with a history of using a brand-name drug can be tagged, such that when the tagged consumer later submits a claim for a corresponding generic drug, the consumer receives a reward (e.g., reduced or waived co-pay).

In some embodiments, the dispositive outcome further comprises communicating with the consumer (e.g., to inform and/or congratulate the consumer for having earned a reward, to educate the consumer about ways in which to achieve a desired behavior, to provide encouragement to the consumer en route to the consumer reaching the threshold achievement at which a reward will be provided, etc.). In some embodiments, the communicating comprises sending the consumer a communication. All manner of communications—including but not limited to electronic transmissions (e.g., electronic mail; text messages; social media posts, such as posts on TWITTER, FACEBOOK, TUMBLR, INSTAGRAM, LINKEDIN, MYSPACE, FOURSQUARE, WORDPRESS, YELP, REDDIT, and/or the like, and combinations thereof; etc.), verbal communication (e.g., a message read to the consumer at the point of sale, such as by a cashier; an automated telephone call; an interactive voice response system; etc.), and/or physical documentation (e.g., printed materials mailed to the consumer and/or hand-delivered to the consumer at a point of sale, etc.)—are contemplated for use in accordance with the present teachings.

The above description of methods of processing applications for compensation is intended to be illustrative. In some embodiments, the application for compensation comprises a health insurance claim, and the processing hub comprises an insurance claims processing system. In such embodiments, the present teachings also provide methods of processing health insurance claims, as further described below.

A method of processing a health insurance claim in accordance with the present teachings comprises: (a) receiving a health insurance claim submitted to an insurance claims processing system by and/or on behalf of a consumer through a point of sale and/or a system coupled therewith; (b) identifying the health insurance claim as being eligible for rewards-based processing; (c) evaluating the health insurance claim in response to the receiving based on data associated with the consumer and/or the health insurance claim and/or the point of sale; (d) determining a dispositive outcome for the health insurance claim, wherein the dispositive outcome comprises rewarding the consumer for exhibiting a desired behavior; and (e) implementing the dispositive outcome at the point of sale. In some embodiments, a method of processing health insurance claims in accordance with the present teachings is implemented using a computer.

In some embodiments, as described above, the present teachings provide methods for processing applications for compensation. In some embodiments, as further described above, the present teachings provide methods for processing health insurance claims. In additional embodiments, as further described below, the present teachings also provide systems for processing applications for compensation.

A first system for processing an application for compensation in accordance with the present teachings comprises a processor coupled to a non-transitory memory. In some embodiments, the processor is operative to: (a) receive an application for compensation submitted to a processing hub through a point of sale and/or a system coupled therewith; (b) evaluate the application for compensation responsive to receipt thereof based on data associated with a consumer and/or the application for compensation and/or the point of sale; (c) determine a dispositive outcome for the application for compensation, wherein the dispositive outcome comprises rewarding the consumer for exhibiting a desired behavior and/or penalizing the consumer for not exhibiting a desired behavior; and (d) implement the dispositive outcome at the point of sale.

In some embodiments, the processor is further operative to identify the application for compensation as being eligible for rewards-based processing. In some embodiments, the processor is remote from the point of sale. In some embodiments, the processor is further operative to receive data provided by the consumer at the point of sale. In some embodiments, the processor is further operative to access data from a database coupled to the processor. In some embodiments, the processor is further operative to adjust a value of awards points credited to the consumer. In some embodiments, the processor is further operative to determine whether a subset of required criteria have been satisfied. In some embodiments, the rewarding is deferred until the value of awards points meets or exceeds a threshold. In some embodiments, the processor is further operative to tag the application for compensation and/or the consumer according to a business rule. In some embodiments, the processor is further operative to initiate communication with the consumer. In some embodiments, the processor is further operative to perform one, all, or a subset of the above-described functions.

As further described below, some embodiments in accordance with the present teachings may be implemented as part of an EBM module. However, it will be appreciated that the mechanisms described herein may be implemented at any logical and/or physical point(s), or combinations thereof, at which the relevant data may be monitored or is otherwise accessible and/or measurable, including but not limited to in one or more gateway devices, modems, computers and/or terminals of one or more points of sale, processing hubs, or the like.

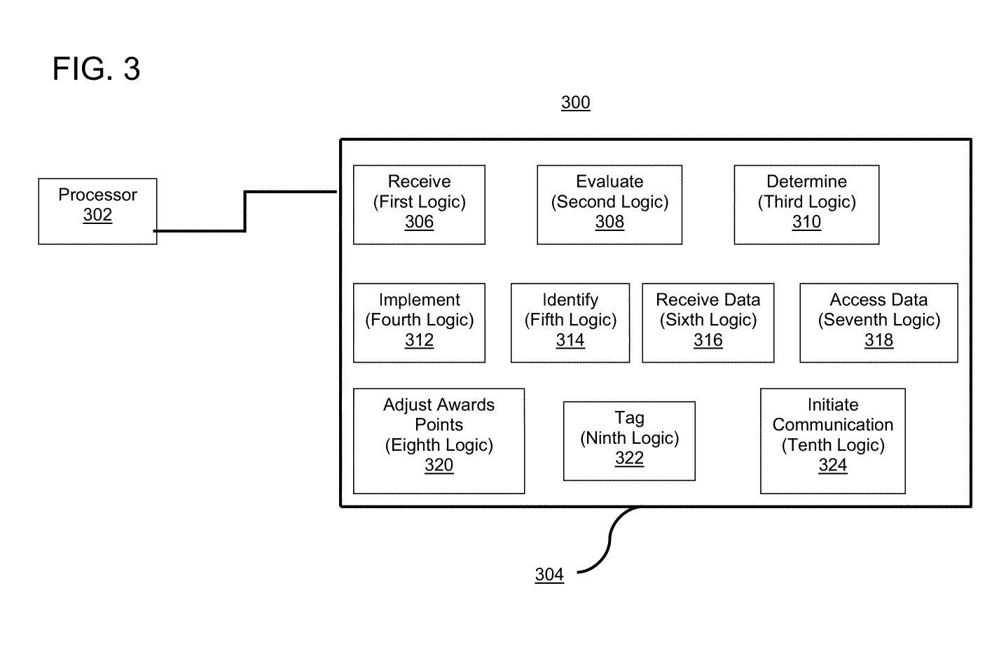

FIG. 3 depicts a block diagram of a representative second system 300 for processing an application for compensation in accordance with the present teachings which, in some embodiments, is implemented as part of an EBM module in a computer system.

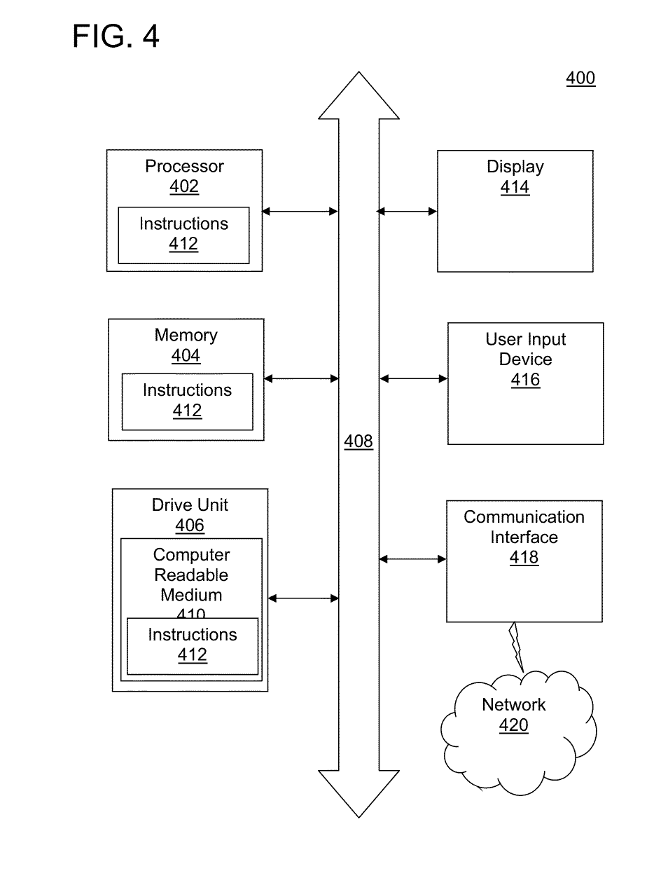

In some embodiments, the system 300 comprises a processor 302 and a non-transitory memory 304 coupled therewith, which may be implemented as a processor 402 and a memory 404 as described below with respect to FIG. 4. In some embodiments, the system 300 further includes first logic 306 stored in the memory 304 and executable by the processor 302 to cause the processor 302 to receive an application for compensation submitted to a processing hub through a point of sale and/or a system coupled therewith; second logic 308 stored in the memory 304 and executable by the processor 302 to cause the processor 302 to evaluate the application for compensation responsive to receipt thereof based on data associated with a consumer and/or the application for compensation and/or the point of sale; third logic 310 stored in the memory 304 and executable by the processor 302 to cause the processor 302 to determine a dispositive outcome for the application for compensation, wherein the dispositive outcome comprises rewarding the consumer for exhibiting a desired behavior and/or penalizing the consumer for not exhibiting a desired behavior; and fourth logic 312 stored in the memory 304 and executable by the processor 302 to cause the processor 302 to implement the dispositive outcome at the point of sale.

In some embodiments, the system 300 may be coupled to other modules of a computer system and/or to other databases so as to have access to the relevant parameters as described herein and initiate the requisite actions as further described below.

In some embodiments, as shown in FIG. 3, the system 300 further includes fifth logic 314 stored in the memory 304 and executable by the processor 302 to cause the processor 302 to identify the application for compensation as being eligible for rewards-based processing. In some embodiments, the system 300 further includes sixth logic 316 stored in the memory 304 and executable by the processor 302 to cause the processor 302 to receive data provided by the consumer at the point of sale. In some embodiments, the system 300 further includes seventh logic 318 stored in the memory 304 and executable by the processor 302 to cause the processor 302 to access data from a database (not shown) coupled to the processor. In some embodiments, the system 300 further includes eighth logic 320 stored in the memory 304 and executable by the processor 302 to cause the processor 302 to adjust a value of awards points credited to the consumer. In some embodiments, the system 300 further includes ninth logic 322 stored in the memory 304 and executable by the processor 302 to cause the processor 302 to tag the application for compensation and/or the consumer according to a business rule. In some embodiments, the system 300 further includes tenth logic 324 stored in the memory 304 and executable by the processor 302 to cause the processor 302 to initiate communication with the consumer. In some embodiments, the processor is operative to perform only one, all, or a subset of the above-described functions.

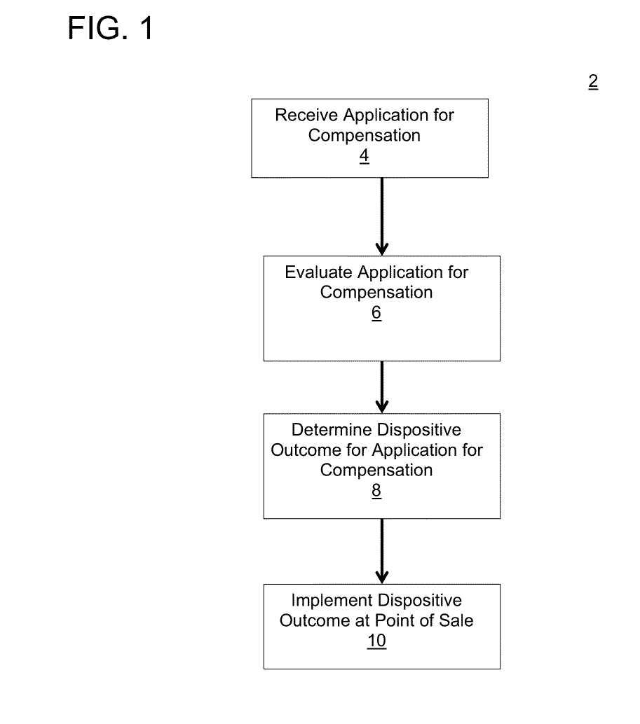

FIG. 1 depicts a flow chart showing exemplary operation of the system 300 of FIG. 3. In particular, FIG. 1 shows a computer-implemented method of processing an application for compensation in accordance with the present teachings that comprises: (a) receiving 4, by a processor, an application for compensation submitted to a processing hub through a point of sale and/or a system coupled therewith; (b) evaluating 6, by the processor, the application for compensation in response to the receiving based on data associated with a consumer and/or the application for compensation and/or the point of sale; (c) determining 8, by the processor, a dispositive outcome for the application for compensation, wherein the dispositive outcome comprises rewarding the consumer for exhibiting a desired behavior and/or penalizing the consumer for not exhibiting a desired behavior; and (d) implementing 10, by the processor, the dispositive outcome at the point of sale.

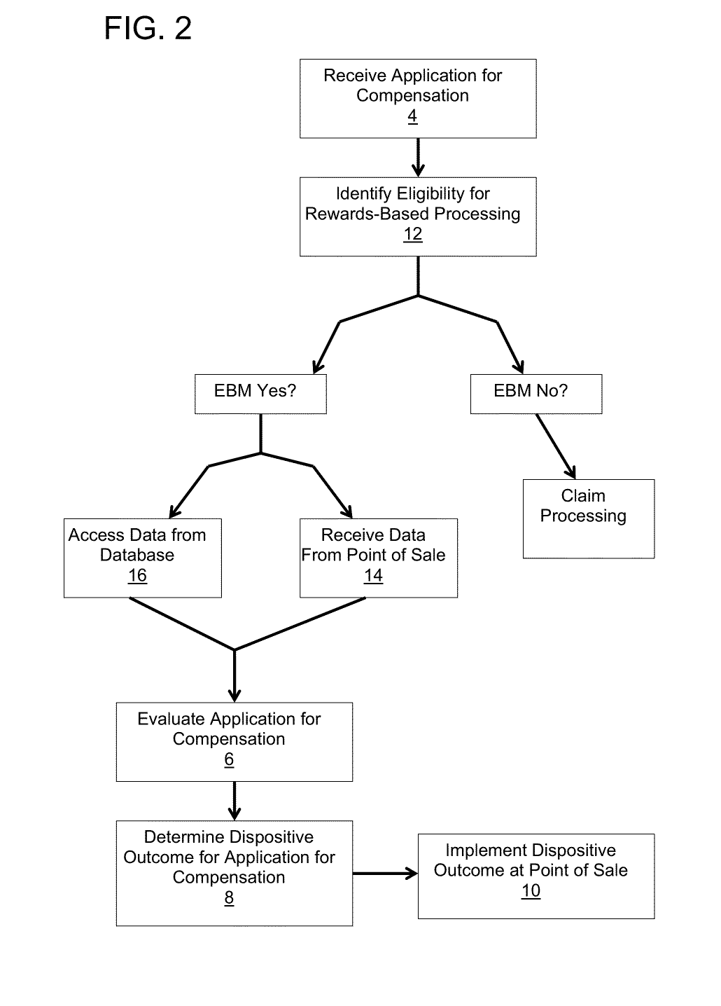

In some embodiments, as shown in the flowchart of FIG. 2 where like referenced numerals refer to like elements in FIG. 1 unless otherwise specified, a computer-implemented method of processing an application for compensation in accordance with the present teachings further comprises (e) identifying 12 the application for compensation as being eligible for rewards-based processing. In some embodiments, as shown in FIG. 2, a computer-implemented method of processing an application for compensation in accordance with the present teachings further comprises (f) receiving 14 data provided by the consumer at the point of sale. In some embodiments, as further shown in FIG. 2, a computer-implemented method of processing an application for compensation in accordance with the present teachings further comprises (g) accessing 16 data from a database coupled to the processor. In some embodiments, a computer-implemented method of processing an application for compensation in accordance with the present teachings further comprises only one, all, or a subset of acts (e), (f), and (g).

It is to be understood that the relative ordering of some acts shown in the flow charts of FIGS. 1 and/or 2 is meant to be merely representative rather than limiting, and that alternative sequences may be followed. Moreover, it is likewise to be understood that additional, different, or fewer acts may be provided. By way of non-limiting and representative example, in FIG. 2, the act of receiving 14 data provided by the consumer at the point of sale is shown as being substantially contemporaneous with the act of accessing 16 data from a database coupled to the processor. However, in alternative embodiments, these acts may occur sequentially and in any order.

A third system for processing an application for compensation in accordance with the present teachings comprises: means for receiving an application for compensation submitted to a processing hub through a point of sale and/or a system coupled therewith; means for evaluating the application for compensation responsive to receipt thereof based on data associated with a consumer and/or the application for compensation and/or the point of sale; means for determining a dispositive outcome for the application for compensation, wherein the dispositive outcome comprises rewarding the consumer for exhibiting a desired behavior and/or penalizing the consumer for not exhibiting a desired behavior; and means for implementing the dispositive outcome at the point of sale.

A fourth system for processing an application for compensation in accordance with the present teachings comprises: (a) a memory operative to store data associated with a consumer and/or the application for compensation and/or the point of sale; (b) an interface coupled with the memory and operative to receive the application for compensation transmitted through a point of sale; and (c) a processor coupled with the interface and operative to (i) evaluate the application for compensation responsive to receipt thereof based on the data, (ii) determine a dispositive outcome for the application for compensation, and (iii) implement the dispositive outcome at the point of sale. In some embodiments, the dispositive outcome comprises rewarding the consumer for exhibiting a desired behavior and/or penalizing the consumer for not exhibiting a desired behavior.

The above description of systems of processing applications for compensation is intended to be illustrative. In some embodiments, the application for compensation comprises a health insurance claim, and the processing hub comprises an insurance claims processing system. In such embodiments, the present teachings also provide systems of processing health insurance claims, as further described below.

A first system for processing a health insurance claim in accordance with the present teachings comprises a processor coupled to a non-transitory memory. In some embodiments, the processor is operative to: (a) receive a health insurance claim submitted to an insurance claims processing system by and/or on behalf of a consumer through a point of sale and/or a system coupled therewith; (b) identify the health insurance claim as being eligible for rewards-based processing; (c) evaluate the health insurance claim responsive to receipt thereof based on data associated with the consumer and/or the health insurance claim and/or the point of sale; (d) determine a dispositive outcome for the health insurance claim, wherein the dispositive outcome comprises rewarding the consumer for exhibiting a desired behavior; and (e) implement the dispositive outcome at the point of sale.

A second system for processing a health insurance claim in accordance with the present teachings comprises: a processor; a non-transitory memory coupled to the processor; first logic stored in the memory and executable by the processor to cause the processor to receive a health insurance claim submitted to an insurance claims processing system by and/or on behalf of a consumer through a point of sale and/or a system coupled therewith; second logic stored in the memory and executable by the processor to cause the processor to identify the health insurance claim as being eligible for rewards-based processing; third logic stored in the memory and executable by the processor to cause the processor to evaluate the health insurance claim responsive to receipt thereof based on data associated with the consumer and/or the health insurance claim and/or the point of sale; fourth logic stored in the memory and executable by the processor to cause the processor to determine a dispositive outcome for the health insurance claim, wherein the dispositive outcome comprises rewarding the consumer for exhibiting a desired behavior; and fifth logic stored in the memory and executable by the processor to cause the processor to implement the dispositive outcome at the point of sale.

A third system for processing a health insurance claim in accordance with the present teachings comprises: means for receiving an insurance claim submitted to an insurance claims processing system by and/or on behalf of a consumer through a point of sale and/or a system coupled therewith; means for identifying the health insurance claim as being eligible for rewards-based processing; means for evaluating the health insurance claim responsive to receipt thereof based on data associated with the consumer and/or the health insurance claim and/or the point of sale; means for determining a dispositive outcome for the health insurance claim, wherein the dispositive outcome comprises rewarding the consumer for exhibiting a desired behavior; and means for implementing the dispositive outcome at the point of sale.

A fourth system for processing a health insurance claim in accordance with the present teachings comprises: (a) a memory operative to store data associated with a consumer and/or the health insurance claim and/or a point of sale; (b) an interface coupled with the memory and operative to receive the health insurance claim transmitted through the point of sale and/or a system coupled therewith by and/or on behalf of the consumer; and (c) a processor coupled with the interface and operative to (i) identify the health insurance claim as being eligible for rewards-based processing, (ii) evaluate the health insurance claim responsive to receipt thereof based on the data, (iii) determine a dispositive outcome for the health insurance claim, and (iv) implement the dispositive outcome at the point of sale. In some embodiments, the dispositive outcome comprises rewarding the consumer for exhibiting a desired behavior.

In some embodiments, as described above, the present teachings provide systems for processing applications for compensation. In some embodiments, as further described above, the present teachings provide systems for processing health insurance claims. In additional embodiments, as further described below, the present teachings also provide application-processing servers for processing applications for compensation.

An application processing server for processing an application for compensation in accordance with the present teachings within a client-server architecture that comprises one or a plurality of clients in communication, via a network, with one or a plurality of servers comprises: a processor; a memory coupled with the processor; an interface coupled with the processor and the memory and configured for communicating, via the network, with at least a first client of the one or the plurality of clients; first logic stored in the memory and executable by the processor to cause the processor to receive an application for compensation submitted by the first client through a point of sale and/or a system coupled therewith; second logic stored in the memory and executable by the processor to cause the processor to evaluate the application for compensation responsive to receipt thereof based on data associated with a consumer and/or the application for compensation and/or the point of sale; third logic stored in the memory and executable by the processor to cause the processor to determine a dispositive outcome for the application for compensation, wherein the dispositive outcome comprises rewarding the consumer for exhibiting a desired behavior and/or penalizing the consumer for not exhibiting a desired behavior; and fourth logic stored in the memory and executable by the processor to cause the processor to provide data concerning the dispositive outcome for presentation to the first client at the point of sale. In some embodiments, the application processing server comprises an insurance claims processing server.

The above description of application processing servers for processing applications for compensation is intended to be illustrative. In some embodiments, the application for compensation comprises a health insurance claim, and the processing hub comprises an insurance claims processing system. In such embodiments, the present teachings also provide insurance claims processing servers, as further described below.

An insurance claims processing server for processing a health insurance claim in accordance with the present teachings within a client-server architecture that comprises one or a plurality of clients in communication, via a network, with one or a plurality of servers, comprises: a processor; a memory coupled with the processor; an interface coupled with the processor and the memory and configured for communicating, via the network, with at least a first client of the one or the plurality of clients; first logic stored in the memory and executable by the processor to cause the processor to receive a health insurance claim submitted by the first client through a point of sale and/or a system coupled therewith; second logic stored in the memory and executable by the processor to cause the processor to identify the health insurance claims as being eligible for rewards-based processing; third logic stored in the memory and executable by the processor to cause the processor to evaluate the health insurance claim responsive to receipt thereof based on data associated with the consumer and/or the health insurance claim and/or the point of sale; fourth logic stored in the memory and executable by the processor to cause the processor to determine a dispositive outcome for the health insurance claim, wherein the dispositive outcome comprises rewarding the consumer for exhibiting a desired behavior; and fifth logic stored in the memory and executable by the processor to cause the processor to provide data concerning the dispositive outcome for presentation to the first client at the point of sale.

In some embodiments, as described above, the present teachings provide application-processing servers for processing applications for compensation. In some embodiments, as further described above, the present teachings provide insurance claims processing servers for processing applications for compensation. In additional embodiments, as further described below, the present teachings also provide non-transitory computer readable storage media.

A non-transitory computer readable storage medium in accordance with the present teachings has stored therein data representing instructions executable by a programmed processor for processing an application for compensation. In some embodiments, the storage medium comprises instructions for: (a) receiving an application for compensation submitted to a processing hub through a point of sale and/or a system coupled therewith; (b) evaluating the application for compensation in response to the receiving based on data associated with a consumer and/or the application for compensation and/or the point of sale; (c) determining a dispositive outcome for the application for compensation, wherein the dispositive outcome comprises rewarding the consumer for exhibiting a desired behavior and/or penalizing the consumer for not exhibiting a desired behavior; and (d) implementing the dispositive outcome at the point of sale.

The above description of non-transitory computer readable storage medium having instructions for processing applications for compensation is intended to be illustrative. In some embodiments, the application for compensation comprises a health insurance claim, and the processing hub comprises an insurance claims processing system. In such embodiments, the present teachings also provide non-transitory computer readable storage medium having instructions for processing health insurance claims, as further described below.

A non-transitory computer readable storage medium in accordance with the present teachings has stored therein data representing instructions executable by a programmed processor for processing a health insurance claim. In some embodiments, the storage medium comprises instructions for: (a) receiving a health insurance claim submitted to an insurance claims processing system by and/or on behalf of a consumer through a point of sale and/or a system coupled therewith; (b) identifying the health insurance claim as being eligible for rewards-based processing; (c) evaluating the health insurance claim in response to the receiving based on data associated with the consumer and/or the health insurance claim and/or the point of sale; (d) determining a dispositive outcome for the health insurance claim, wherein the dispositive outcome comprises rewarding the consumer for exhibiting a desired behavior; and (e) implementing the dispositive outcome at the point of sale.

In the methods, systems, and servers for processing health insurance claims described above, and in the computer-readable storage media comprising instructions for processing health insurance claims further described above, the desired behavior of the consumer that is to be rewarded in accordance with the present teachings is not restricted. Although the desired behavior is not restricted, in some embodiments, the desired behavior comprises one or a plurality of the following types of representative desired behaviors: (a) selecting a preferred first option for filling a prescription from amongst a plurality of other less preferred options; (b) demonstrating receptivity towards healthful information proffered to the consumer; (c) monitoring a disease state (e.g., particularly, though not necessarily, when the consumer has, or is at risk of having, the particular disease state); and (d) adhering to a prescribed therapeutic regimen for treating a disease state (e.g., particularly, though not necessarily, when the consumer has, or is at risk of having, the particular disease state).

In some embodiments, the desired behavior comprises selecting a preferred first option for filling a prescription from amongst a plurality of other less preferred options. In some embodiments, the first option has a lower cost than one or a plurality of the other less preferred options. In some embodiments, the desired behavior comprises electing to receive a generic drug instead of a brand-name drug. In some embodiments, the desired behavior comprises filling a prescription through an online or mail order pharmacy instead of at a retail pharmacy. In some embodiments, the desired behavior comprises electing to receive a generic drug instead of a non-corresponding brand-name drug, wherein the generic drug and the non-corresponding brand-name drug are in the same class (e.g., there is not a generic drug that corresponds exactly with a particular brand-name drug, but there is a generic drug in the same class as the brand-name drug that can be substituted for the brand-name drug). In some embodiments, the desired behavior comprises electing to receive a first quantity of a prescription (e.g., a 90-day supply) instead of a second smaller quantity of the prescription (e.g., a 30-day supply), for example, to reduce administrative and/or other costs. In some embodiments, the desired behavior comprises electing to receive a first quantity of a prescription (e.g., a 30-day supply) instead of a second larger quantity of the prescription (e.g., a 90-day supply), for example, to promote increased interaction (e.g., and monitoring) between consumer and provider.

In some embodiments, the desired behavior comprises receptivity towards healthful information proffered to the consumer. In some embodiments, the receptivity towards the healthful information comprises participation in and/or completion of a program. In some embodiments, the program provides educational information designed to control, treat and/or prevent a disease state. The type of disease state to be controlled, treated and/or prevented in accordance with the present teachings is not restricted and all manner of disease states are contemplated for use. By way of non-limiting example, representative disease states include but are not limited to hypertension, diabetes, heart disease, high cholesterol, obesity, addictions (e.g., nicotine, drugs, alcohol, etc.), mental disorders (e.g., depression, schizophrenia, etc.), cancer, stroke, orthopedic injuries, dental problems (e.g., gingivitis, decay, etc.), and the like, and combinations thereof. In some embodiments, the program is selected from the group consisting of smoking and/or nicotine cessation therapies, substance abuse treatments, mutual aid fellowships (e.g., twelve-step programs, including but not limited to Alcoholics Anonymous, Narcotics Anonymous, Overeaters Anonymous, etc.), patient counseling programs, behavior modification programs, disease prevention programs, disease control programs, weight loss programs (e.g., Weight Watchers, etc.), diet programs, nutrition programs, stress reduction programs, healthy lifestyle programs, and combinations thereof. In some embodiments, the receptivity towards the healthful information comprises accepting educational literature provided to the consumer and/or optionally demonstrating a threshold mastery of knowledge obtained from the educational literature (e.g., by requiring the consumer to pass a test offered in-person and/or via the Internet; by requiring attendance at some form of seminar, including but not limited to in-person attendance at a physical seminar and/or virtual attendance via an online offering; etc.). In some embodiments, the rewarding is triggered by registration (e.g., signing in, etc.) in a physical and/or virtual seminar.

In some embodiments, the consumer has a disease state, and the desired behavior comprises monitoring the disease state. In some embodiments, the disease state is controllable through behavior modification. The type of disease state to be controlled in accordance with the present teachings is not restricted and all manner of disease states are contemplated for use. By way of non-limiting example, representative disease states include but are not limited to hypertension, diabetes, heart disease, high cholesterol, obesity, addictions (e.g., nicotine, drugs, alcohol, etc.), mental disorders (e.g., depression, schizophrenia, etc.), cancer, stroke, orthopedic injuries, dental problems (e.g., gingivitis, decay, etc.), and the like, and combinations thereof. In some embodiments, the monitoring comprises obtaining one or a plurality of measurements indicative of a status of the disease state. The type of measurements obtained is not restricted, with representative measurements including but not limited to blood pressure (e.g., for monitoring hypertension); blood glucose level (e.g., for monitoring diabetes); total cholesterol, LDL cholesterol, HDL cholesterol, and/or triglyceride levels (e.g., for monitoring high cholesterol); weight (e.g., for monitoring obesity); blood concentrations of a drug (e.g., nicotine, narcotics, and/or the like) and/or alcohol in the blood (e.g., for monitoring addiction); presence and/or concentration of a drug in urine and/or hair (e.g., for monitoring addiction); and combinations thereof.

In some embodiments, the desired behavior further comprises reporting the one or the plurality of the measurements to an entity selected from the group consisting of a health-care provider, an insurance company, an affiliate of the insurance company, or combinations thereof. In some embodiments, the reporting comprises wired and/or wireless transmission of data over a network. In some embodiments, the desired behavior further comprises performing the monitoring in accordance with a regular testing schedule. In some embodiments, the monitoring comprises using a device (e.g., a blood glucose monitor, blood pressure monitor, scale, etc.), which may or may not automatically report the measurement to an entity (e.g., a health-care provider, an insurance company, an affiliate of the insurance company, or combinations thereof). In some embodiments, the disease state comprises diabetes, and the monitoring comprises blood sugar testing.

In some embodiments, the consumer has a disease state, and the desired behavior comprises adhering to a prescribed therapeutic regimen for treating the disease state. As used herein, the phrase “therapeutic regimen” is used synonymously with the phrase “treatment regimen” and includes all manner of recommended treatment (e.g., drugs, therapy, counseling, education, etc.) prescribed by a health care provider.

In some embodiments, the therapeutic regimen comprises using a maintenance drug. As used herein, the phrase “maintenance drug” refers to a drug for treating a chronic, long term condition that is taken on a regular and/or recurring basis. In some embodiments, the maintenance drug is used for treating a disease state and/or for controlling and/or managing one or more symptoms thereof. The type of disease state to be treated by a prescribed therapeutic regimen in accordance with the present teachings is not restricted and all manner of disease states are contemplated for use. By way of non-limiting example, representative disease states include but are not limited to hypertension, diabetes, heart disease, high cholesterol, obesity, addictions (e.g., nicotine, drugs, alcohol, etc.), mental disorders (e.g., depression, schizophrenia, etc.), cancer, stroke, orthopedic injuries, dental problems (e.g., gingivitis, decay, etc.), and the like, and combinations thereof. In some embodiments, the disease state is selected from the group consisting of high blood pressure, high cholesterol, diabetes, and combinations thereof. In some embodiments, the desired behavior further comprises filling a prescription for the maintenance drug. In some embodiments, the desired behavior further comprises filling a prescription for the maintenance drug a predetermined number of times. In some embodiments, the rewarding is deferred until the prescription has been filled the predetermined number of times. In some embodiments, the desired behavior further comprises filling the prescription prior to a refill date and/or within a predetermined number of days subsequent to the refill date.

For simplicity, embodiments of the present teachings described above are presented in the context of a three-party system that includes (1) the consumer; (2) the point of sale (e.g., a provider of goods and services, such as a pharmacy, a hospital, a physician, or the like); and (3) the processing hub (e.g., an insurance company or an affiliate thereof). However, the present teachings are not restricted to a three-party system and, in some embodiments, are applicable in systems that further include one or a plurality of additional entities (e.g., a system that involves multiple points of sale, such as a plurality of different health care providers). By way of non-limiting and representative example, in some embodiments, a four-party system includes (1) the consumer; (2) a first point of sale (e.g., a first provider of goods and services, such as a pharmacy); (3) a second point of sale (e.g., a second provider of goods and services, such as a hospital or physician); and (4) the processing hub.

In some embodiments, in addition to, or as an alternative to, rewarding the consumer for exhibiting desired behavior, one or more additional or alternative entities (e.g., a first point of sale and/or a second point of sale, etc.) may likewise be rewarded for exhibiting a desired behavior.

In some embodiments, systems and methods are disclosed for processing applications for compensation—including but not limited to insurance claims and, in some embodiments, including but not limited to health insurance claims. Some embodiments are desirably implemented with computer devices and computer networks, such as those shown in FIG. 4 and described below. It will be appreciated that the plurality of entities utilizing embodiments in accordance with the present teachings (e.g., consumers, points of sale, processing hubs, etc.) may be referred to by other nomenclature reflecting the role that the particular entity is performing with respect to a particular embodiment, and that a given entity may perform more than one role depending upon the implementation and the nature of the particular transaction being undertaken.

Systems in accordance with the present teachings, including but not limited to system 300 shown in FIG. 3, may be implemented with one or more mainframe, desktop, and/or other computers, including but not limited to the computer 400 described below with respect to FIG. 4. In some embodiments, a database may be provided which includes information associated with a consumer and/or an application for compensation and/or a point of sale.

It will be appreciated that the types of computer devices deployed by points of sale and/or processing hubs, and the methods and media by which they communicate, are implementation dependent and may vary. In addition, not all of the computer devices and/or means/media of communication may be used; other computer devices and/or means/media of communications—now available or later developed—may be used. In some embodiments, each computer device, which may comprise a computer 400 described in more detail below with respect to FIG. 4, may independently include a central processor that controls the overall operation of the computer and a system bus that connects the central processor to one or more conventional components, such as a network card or modem. In some embodiments, each computer device may also independently include a variety of interface units and drives for reading and writing data or files and communicating with other computer devices. Depending on the type of computer device, a user can interact with the computer with a keyboard, pointing device, touch interface, microphone, pen device or other input device now available or later developed.

In some embodiments, computer devices can be directly connected, such as via a T1 line, a common local area network (LAN), and/or other wired and/or wireless media for connecting computer devices. In some embodiments, computer devices may also connected to a radio. The user of radio, which may include a cellular telephone, smart phone, or other wireless proprietary and/or non-proprietary device, may be associated with the consumer, the point of sale, and/or the processing hub. In some embodiments, the radio user may transmit an application for compensation or other information to an exemplary computer device (e.g., at the processing hub, etc.) or a user thereof. The user of the exemplary computer device that receives the application for compensation, or the exemplary computer device alone and/or autonomously, may then transmit information (e.g., information associated with the dispositive outcome) in response.

In some embodiments, exemplary computer devices are coupled with a LAN that may be configured in one or more of the well-known LAN topologies (e.g. star, daisy chain, and the like) and may use a variety of different protocols including but not limited to an Ethernet, TCP/IP, or the like, and combinations thereof. In some embodiments, exemplary computer devices may communicate with each other and with other computer and other devices that are coupled with the LAN. Computers and other devices may be coupled with the LAN via twisted pair wires, coaxial cable, fiber optics, other wired or wireless media, or the like, and combinations thereof. For example, wireless personal digital assistant device (PDA)—such as a mobile telephone, tablet-based computer device, or other wireless device—may communicate with the LAN and/or the Internet via radio waves (e.g., via Wi-Fi, Bluetooth and/or a cellular telephone based data communications protocol). The PDA may also communicate via a conventional wireless hub.

In some embodiments, the LAN can be coupled with a wide area network (WAN), which may be comprised of one or more public or private wired or wireless networks. In some embodiments, the WAN includes the Internet. In some embodiments, the LAN may include a router to connect LAN to the Internet. In some embodiments, a computer device can be coupled directly to the Internet, such as via a modem, DSL line, satellite dish or any other device for connecting a computer device to the Internet via a service provider.

In some embodiments, the operations of computer devices and systems such as those shown in FIG. 3 may be controlled by computer-executable instructions stored on a non-transitory computer-readable medium.

Of course, in some embodiments, numerous additional servers, computers, handheld devices, personal digital assistants, telephones and other devices may also be connected to a computer system in accordance with the present teachings. Moreover, one skilled in the art will appreciate that the topology described above is merely representative, and that the system may include other components not shown and/or be connected by numerous alternative topologies.

Some embodiments in accordance with the present teachings may be implemented as part of an EBM module. However, it will be appreciated that the mechanisms described herein may be implemented at any logical and/or physical point(s), or combinations thereof, at which the relevant data may be monitored or is otherwise accessible and/or measurable, including but not limited to in one or more gateway devices, modems, computers and/or terminals of one or points of sale or the like.

One skilled in the art will appreciate that one or more modules or logic described herein may be implemented using, among other things, a tangible computer-readable medium comprising computer-executable instructions (e.g., executable software code). Alternatively, in some embodiments, modules may be implemented as software code, firmware code, hardware, and/or a combination of the aforementioned. By way of non-limiting and representative example, in some embodiments, the modules may be embodied as part of a system for processing applications for compensation.

FIG. 4 shows a representative embodiment of a general computer system 400. In some embodiments, the computer system 400 includes a set of instructions that can be executed to cause the computer system 400 to perform any one or more of the methods or computer-based functions described herein. In some embodiments, the computer system 400 may operate as a standalone device or, in other embodiments, may be connected (e.g., using a network) to other computer systems and/or peripheral devices. Any of the components described above, including but not limited to the processor 202, may be a computer system 400 or a component in the computer system 400. In some embodiments, the computer system 400 may implement a method, system or sever for event-based management, of which embodiments in accordance with the present teachings are a component thereof.

In some embodiments, in a networked deployment, the computer system 400 may operate in the capacity of a server or as a client user computer in a client-server user network environment, or as a peer computer system in a peer-to-peer (or distributed) network environment. In some embodiments, the computer system 400 can also be implemented as or incorporated into various devices, including but not limited to a personal computer (PC), a tablet PC, a set-top box (STB), a PDA, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, any other machine capable of executing a set of instructions (sequential or otherwise) that specify actions to be taken by that machine, or the like, and combinations thereof. In some embodiments, the computer system 400 can be implemented using electronic devices that provide voice, video or data communication. Further, it is to be understood that while a single computer system 400 is illustrated, the term “system” as used herein is meant to include any collection of systems or sub-systems that individually or jointly execute a set, or multiple sets, of instructions to perform one or more computer functions.

As shown in FIG. 4, the computer system 400 may include a processor 402, such as a central processing unit (CPU), a graphics-processing unit (GPU), or both. In some embodiments, the processor 402 may be a component in a variety of systems. For example, the processor 402 may be part of a standard personal computer or a workstation. In some embodiments, the processor 402 may be one or more general processors, digital signal processors, application-specific integrated circuits, field programmable gate arrays, servers, networks, digital circuits, analog circuits, other now-known or later-developed devices for analyzing and processing data, or combinations thereof. In some embodiments, the processor 402 may implement a software program, such as code generated manually (i.e., programmed).

In some embodiments, the computer system 400 may include a memory 404 that can communicate via a bus 408. In some embodiments, the memory 404 may be a main memory, a static memory, or a dynamic memory. In some embodiments, the memory 404 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, or the like, and combinations thereof. In some embodiments, the memory 404 includes a cache or random access memory for the processor 402. In some embodiments, the memory 404 is separate from the processor 402, such as a cache memory of a processor, the system memory, or other memory. In some embodiments, the memory 404 may be an external storage device or database for storing data. Examples include but are not limited to a hard drive, compact disc (CD), digital video disc (DVD), memory card, memory stick, floppy disc, universal serial bus (USB) memory device, any other device operative to store data, or combinations thereof. In some embodiments, the memory 404 is operable to store instructions executable by the processor 402. In some embodiments, the functions, acts, or tasks illustrated in the figures and/or described herein may be performed by the programmed processor 402 executing the instructions 412 stored in the memory 404. In some embodiments, the functions, acts, or tasks are independent of the particular type of instructions set, storage media, processor, and/or processing strategy, and may be performed by software, hardware, integrated circuits, firm-ware, micro-code and the like, operating alone or in combination. Likewise, in some embodiments, processing strategies may include multiprocessing, multitasking, parallel processing, or the like, and combinations thereof.

As shown in FIG. 4, the computer system 400 may further include a display unit 414, such as a liquid crystal display (LCD), an organic light emitting diode (OLED), a flat panel display, a solid state display, a cathode ray tube (CRT), a projector, a printer, other now-known or later-developed display devices for outputting determined information, and combinations thereof. In some embodiments, the display 414 may act as an interface for the user to see the functioning of the processor 402 or, in some embodiments, as an interface with the software stored in the memory 404 or in the drive unit 406.

Additionally, in some embodiments, the computer system 400 may include an input device 416 configured to allow a user to interact with any of the components of system 400. In some embodiments, the input device 416 may be a number pad, a keyboard, or a cursor control device, such as a mouse, a joystick, a touch screen display, a remote control, any other device operative to interact with the system 400, or combinations thereof.

In some embodiments, as shown in FIG. 4, the computer system 400 may also include a disk or optical drive unit 406. In some embodiments, the disk drive unit 406 may include a computer-readable medium 410 in which one or more sets of instructions 412 (e.g., software) can be embedded. Further, in some embodiments, the instructions 412 may embody one or more of the methods or logic as described herein. In some embodiments, the instructions 412 may reside completely, or at least partially, within the memory 404 and/or within the processor 402 during execution by the computer system 400. In some embodiments, the memory 404 and the processor 402 also may include computer-readable media as described above.

In some embodiments in accordance with the present teachings, a computer-readable medium includes instructions 412 or receives and executes instructions 412 responsive to a propagated signal, so that a device connected to a network 420 can communicate voice, video, audio, images, and/or any other data over the network 420. In some embodiments, the instructions 412 may be transmitted or received over the network 420 via a communication interface 418. In some embodiments, the communication interface 418 may be a part of the processor 402 or may be a separate component. In some embodiments, the communication interface 418 may be created in software or may be a physical connection in hardware. In some embodiments, the communication interface 418 is configured to connect with a network 420, external media, the display 414, any other components in system 400, or combinations thereof. In some embodiments, the connection with the network 420 may be a physical connection, such as a wired Ethernet connection or may be established wirelessly as described below. Likewise, in some embodiments, the additional connections with other components of the system 400 may be physical connections or may be established wirelessly.

In some embodiments, the network 420 may include wired networks, wireless networks, or combinations thereof. In some embodiments, the wireless network may be a cellular telephone network, an 802.11, 802.16, 802.20, or WiMax network. In some embodiments, the network 420 may be a public network (e.g., the Internet), a private network (e.g., an intranet), or combinations thereof, and may utilize a variety of networking protocols now available or later developed including but not limited to TCP/IP-based networking protocols.

Embodiments in accordance with the present teachings and the functional operations described in this specification can be implemented in digital electronic circuitry, or in computer software, firmware, and/or hardware, including the structures described in this specification and their structural equivalents, or in combinations of one or more of them. Some embodiments of the subject matter described in this specification can be implemented as one or more computer program products (i.e., one or more modules of computer program instructions encoded on a computer-readable medium for execution by, or to control the operation of, a data processing apparatus). While in some embodiments the computer-readable medium is shown to be a single medium, the term “computer-readable medium” includes a single medium or multiple media, such as a centralized or distributed database, and/or associated caches and servers that store one or more sets of instructions. As used herein, the term “computer-readable medium” shall also include any medium that is capable of storing, encoding, or otherwise carrying a set of instructions for execution by a processor or that cause a computer system to perform any one or more of the methods or operations described herein. In some embodiments, the computer readable medium can be a machine-readable storage device, a machine-readable storage substrate, a memory device, or a combination of one or more of these. As used herein, the term “data processing apparatus” encompasses all apparatuses, devices, and machines for processing data, including but not limited to a programmable processor, a computer, multiple processors, multiple computers, or combinations thereof. In some embodiments, the apparatus can include, in addition to hardware, code that creates an execution environment for the computer program in question (e.g., code that constitutes processor firmware, a protocol stack, a database management system, an operating system, or a combination of one or more of these).

In some embodiments, the computer-readable medium can include a solid-state memory, such as a memory card or other package that houses one or more non-volatile read-only memories. In some embodiments, the computer-readable medium can be a random access memory or other volatile re-writable memory. Additionally, in some embodiments, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application-specific integrated circuits, programmable logic arrays, and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, systems in accordance with the present teachings encompass software, firmware, and hardware implementations.

In some embodiments, the methods described herein may be implemented by software programs executable by a computer system. Furthermore, in some embodiments, implementations can include distributed processing, component/object distributed processing, and parallel processing. In some embodiments, virtual computer system processing can be constructed to implement one or more of the methods or functionality as described herein.

Although the present specification describes components and functions that may be implemented in particular embodiments with reference to particular standards and protocols, the present teachings are not limited to such standards and protocols. By way of non-limiting and representative example, standards for Internet and other packet-switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those described herein are considered equivalents thereof.

A computer program (also known as a program, software, software application, script, and/or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. T he processes and logic flows can also be performed by, and apparatus can also be implemented as, special purpose logic circuitry, such as an FPGA (field programmable gate array) or an ASIC (application-specific integrated circuit).

Representative processors suitable for the execution of a computer program in accordance with the present teachings include but are not limited to both general and special purpose microprocessors, and any one or more processors of any kind of digital computer. Generally, a processor will receive instructions and data from a read-only memory a random access memory, or both. The minimal elements of a computer are a processor for performing instructions and one or more memory devices for storing instructions and data. In some embodiments, a computer will also include, or be operatively coupled to receive data from or transfer data to, or both, one or more mass storage devices for storing data (e.g., magnetic disks, magneto optical disks, or optical disks). However, a computer need not have such devices. Moreover, in some embodiments, a computer can be embedded in another device, such as a mobile telephone, a PDA, a mobile audio player, or a global positioning system (GPS) receiver, to name just a few. Computer readable media suitable for storing computer program instructions and data in accordance with the present teachings include all forms of non-volatile memory, media, and memory devices, including but not limited to semiconductor memory devices (e.g., EPROM, EEPROM, flash memory devices, etc.), magnetic disks (e.g., internal hard disks or removable disks, magneto optical disks, etc.), and CD ROM and DVD-ROM disks. In some embodiments, the processor and/or the memory can be supplemented by, or incorporated in, special purpose logic circuitry.

To provide for interaction with a user, some embodiments can be implemented on a device having a display, such as a CRT or LCD monitor, for displaying information to the user, and a keyboard and a pointing device (e.g., a mouse or a trackball) by which the user can provide input to the computer. Other kinds of devices can be used to provide for interaction with a user as well. By way of non-limiting and representative example, feedback provided to the user can be any form of sensory feedback (e.g., visual feedback, auditory feedback, or tactile feedback), and input from the user can be received in any form (including but not limited to acoustic, speech, and/or tactile input.

Some embodiments in accordance with the present teachings can be implemented in a computing system that includes a back-end component (e.g., as a data server) or that includes a middleware component (e.g., an application server) or that includes a front-end component (e.g., a client computer having a graphical user interface or a Web browser through which a user can interact with an implementation of the subject matter described herein), or any combination of one or more such back-end, middleware, or front-end components. In some embodiments, the components of the system can be interconnected by any form or medium of digital data communication (e.g., a communication network). Examples of communication networks include but are not limited to LANs and WANs (e.g., the Internet).

In some embodiments, the computing system can include clients and servers. A client and server are generally remote from each other and typically interact through a communication network. The relationship of client and server arises by virtue of computer programs running on the respective computers and having a client-server relationship to each other.

The preceding description illustrates features of EBM that can be applied across a wide variety of different types of applications for compensation—including but not limited to insurance claims, and including but not limited to health insurance claims. In the description that follows, for the purpose of representative illustration, examples will be provided for applying and implementing EBM within the context of health insurance claim processing. It is to be understood that the embodiments relating to health insurance claims described below are merely representative and are provided solely by way of illustration. They are not intended to limit the scope of the appended claims or their equivalents.

### EXAMPLES

In some embodiments, EBM is used to supplement a health insurance claims processing system by allowing one or a plurality of a consumer (e.g., an insured entity), a health insurance provider, a health service provider (e.g., a pharmacy), and/or a health insurance claims processing system (e.g., Argus Health Systems, Inc., etc.) to have additional control in supporting consumer-based programs. In some embodiments, EBM is configured to target, intercept, and evaluate specific claims in real-time during point-of-service based on: (a) actionable information (e.g., data collected from physicians, including but not limited to lab reports, lab results, encounter data, visit history, and the like which, in some embodiments, may be collected via the claim that the physician submits to the claim processing system; survey results; evidence of adherence to a member wellness program; diabetic monitoring files; cholesterol tracking programs; and/or the like) provided to a claims processing system from an external source; and/or (b) internal points of data provided via an eligibility file. Based on the specific EBM behavioral intervention strategy and these multiple data points, a customer has the control to change a member's benefit experience (e.g., through payment change protocols) and/or to tag targeted claims for specific labeling and/or communication. In some embodiments, EBM prompts customers to modify behavior through economic incentives.

In some embodiments, an EBM configuration comprises one or a plurality of events, each of which, in some embodiments, describes rules and associated outcome(s) and maintains its own accumulation values. In some embodiments, EBM configurations are first created and saved, and then associated to an offer.

In some embodiments, an EBM service includes implementation, program support, and an ability to track the program. In some embodiments, an EBM program comprises one or more EBM events that together meet a single objective of a claim outcome (e.g., a reduced or waived copay) and/or multiple label outcomes. By way of non-limiting and representative example, a representative EBM program includes but is not limited to diabetic monitoring in which co-pay is reduced or waived for diabetic members who adhere to a baseline blood sugar testing schedule on a regular basis and/or exhibit a desired trend in glucose level measurements (e.g., a downward value trend, a trend indicative of stable values, etc.). An additional representative EBM program includes but is not limited to EBM Behavioral Intervention Strategy, which supports changing a member's benefit experience through payment change protocols (e.g., an adherence program in which co-pay is reduced for members refilling medications on a regular basis, etc.). Further representative examples of EBM programs include but are not limited to member wellness adherence programs, diabetic monitoring files, cholesterol tracking programs, and the like, and combinations thereof.

In some embodiments, EBM evaluates: (a) claims history (e.g., brand-name drug use over a period of time, such as during the preceding six months; etc.); (b) demographics (e.g., pharmacy state or region, etc.); and/or (c) behavior (e.g., survey completion, wireless communication; etc.) at a member level to produce an outcome in real time based on what is of value to the health plan. In some embodiments, the element of a claim that EBM changes is the member pay amount versus the plan pay amount. By way of non-limiting and representative example, in what is referred to herein as a “claim outcome,” EBM may, in some embodiments, change a claim from member pays 100% and plan pays 0% to member pays 0% and plan pays 100%.

In some embodiments, EBM can be configured to work with deductible processing in several ways. By way of non-limiting and representative example, in some embodiments, EBM claims can be excluded from deductible processing. In other embodiments, EBM claims can be included in deductible processing, with various options regarding deductible phase, minimum premium plan (MPP) and maximum out-of pocket (MOP) expense.

In some embodiments, EBM provides a unique labeling feature that can be used to “tag” certain members and/or claims based on established rule sets. Once a label is in place, it can then be used as a criterion for invoking additional EBM programs. By way of non-limiting and representative example, a program may tag members who are using a brand-name drug, and then decrease the co-pay when those tagged members submit a claim for a generic drug.

In some embodiments, EBM is configured for use by associates of a claims processing system (e.g., Argus Health Systems, Inc. associates). In some embodiments, EBM is configured for use by associates of the point of sale (e.g., pharmacy employees). In some embodiments, EBM is configured for use by consumers (e.g., individuals filling prescriptions). In some embodiments, EBM is configured for use by a combination of associates of a claims processing system, associates of the point of sale, and/or consumers.

In some embodiments, EBM is provided with an online utility (e.g., an interface, such as a Claims Viewer) for assisting users in determining what happened to a claim relative to a particular EBM program. In some embodiments, the claim can be viewed relative to the member, the program, and/or other claims.

In some embodiments, EBM can be implemented for only a particular group within a customer hierarchy. For example, in some embodiments, EBM is structured such that it can be implemented for a member population at the customer, client, group, coverage code, or deductible ID level.

In some embodiments, EBM programs can be implemented for a single customer hierarchy. For example, in some embodiments, a program can be configured to run at the customer level while programs are simultaneously running at the client or group level. In some embodiments, a claim receives a single EBM outcome, so the priority of processing is a factor.

In some embodiments, EBM uses rule sets to compare and evaluate data. In some embodiments, the rule sets that drive EBM programs can be created from a wide array of data elements. In some embodiments, these data elements can include drug-related data, pharmacy-related data, prescriber-related data, member-related data, claim-related data, or combinations thereof. In some embodiments, representative drug-related criteria for use in creating rules sets for EBM include but are not limited to NDC (National Drug Code), AHFS (American Hospital Formulary Service) Code, Brand Name, GPI (Generic Product Indicator, also called Generic Price Indicator), Compound Code, Core-9 (e.g., the first 9 digits of the NDC), Drug Class, Drug Form, GCN (Generic Code Number), Generic Name, Manufacturer number (i.e. the first 5 digits of the NDC), Manufacturer name, Strength, Maintenance Drug Indicator (June 2012 release), and the like, and combinations thereof. In some embodiments, representative pharmacy-related criteria for use in creating rules sets for EBM include but are not limited to Pharmacy NCPDP ID, Pharmacy NPI (National Provider Identifier), Pharmacy State, Pharmacy Status Indicator, Pharmacy Zip Code, and the like, and combinations thereof. In some embodiments, representative prescriber-related criteria for use in creating rules sets for EBM include but are not limited to Prescriber ID (not NPI), Prescriber NPI (National Provider Identifier), and the like, and combinations thereof. In some embodiments, representative member-related criteria for use in creating rules sets for EBM include but are not limited to Outcome count, Maximum number of outcomes, Claim count accumulation, Member pay amount accumulation, Plan pay amount accumulation, Quantity accumulation, Strength accumulation, Member label name, Member eligibility begin date, Member eligibility end date, Member date of birth, Member gender, Member state, Member zip code, Miscellaneous Data 1, Miscellaneous Data 2, Miscellaneous Data 3, Flex Report Code, MTM (Medication Therapy Management) Code, MTM Code Effective Date, and the like, and combinations thereof. In some embodiments, representative claim-related criteria for use in creating rules sets for EBM include but are not limited to Member ID, Claim Type, Fill Date, Claim Received Date, Rx Number, Claim member pay amount, Claim plan pay amount, Pricing Source, Plan Days Supply, Plan Metric Quantity, Pre-Auth Number, Pre-Auth Indicator (e.g., the indicator sent by claims processing on an EBM claim indicating that a pre-auth was applied to the claim that overrode the copay), Submitted Total, U & C (Usual and Customary) Amount, Prescription Origin (a.k.a. Prescription Origin Indicator and Prescription Origin Code), Plan Dispense Fee, Plan Total, Strength calculation, and the like, and combinations thereof.

In some embodiments, exception processing is available for EBM programs. By way of non-limiting and representative example, in some embodiments, companion utilities can be used to allow adjustments at a member level. Representative companion utilities that allow adjustments at a member level include but are not limited to Member Outcome Exception (MOE) and Member Accumulation Exception (MAE). In some embodiments, the MOE utility allows an authorized user to create a one-time outcome (e.g., reduced or waived copay) for a member based on a set of rules. In some embodiments, the MAE utility allows an authorized user to adjust a member's accumulation buckets to move the member closer to (or further from) a particular claim outcome.

As used herein, a “behavioral claim” refers to a paid claim that has contributed to a claim outcome (e.g., reduced or waived copay) and/or that was tagged in accordance with an EBM rule set. By way of non-limiting and representative example, if an EBM program design rewards a member for the fifth “on time” claim for a specific generic medication, claims one through four contributed to the outcome and claim five received the outcome. All five claims are considered behavioral claims for billing purposes. Alternatively, if the goal of the same program was to tag the member instead of executing a claim outcome, all five claims would also be considered behavioral claims.

EBM programs can be integrated into health care plans to encourage various desired behaviors, as further described below.

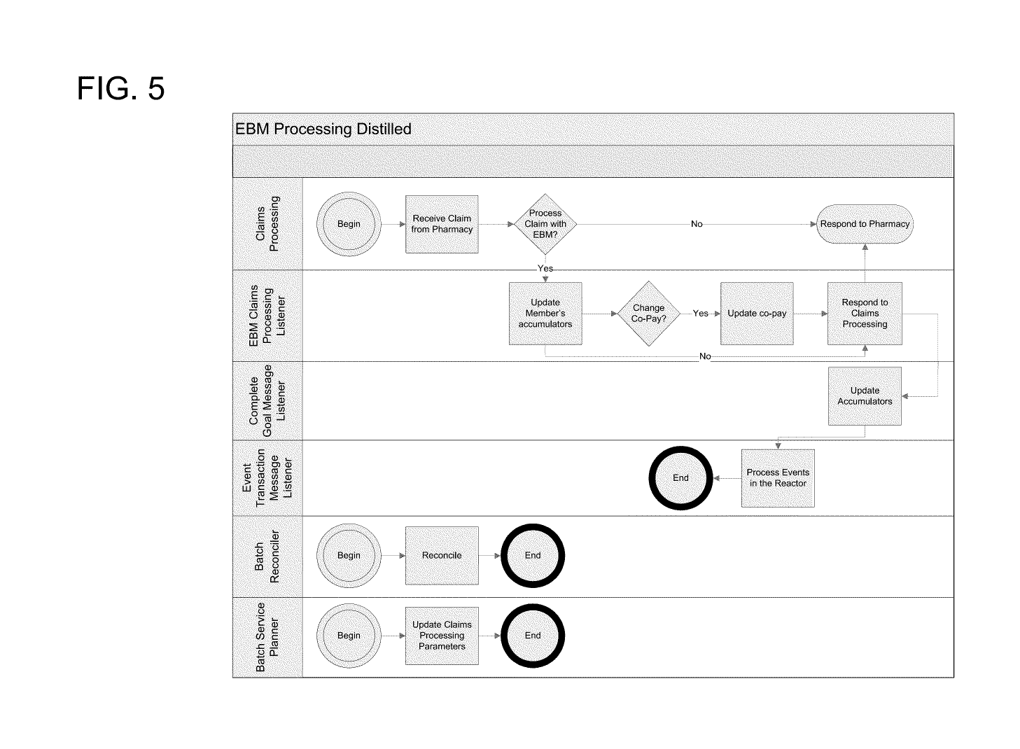

FIG. 5 shows an illustrative embodiment of an EBM processing model implemented as a series of module. In some embodiments, each module is optimized to perform a particular task. In some embodiments, with responsibility thus dispersed, the distribution of processing power allows efficient concurrent processing, individual tuning and maintenance, and limited disability during failure.

As shown in FIG. 5, Claims Processing is the system of the point of sale through which, in some embodiments, claims pay and deny. In some embodiments, Claims Processing is responsible for determining whether an EBM program applies to a claim, writing intermediate claim snapshots for reconciliation, and/or actually altering the pay amount. The EBM Claim Processing Listener shown in FIG. 5 is a module that executes EBM rules on behalf of Claims Processing. In some embodiments, a prime directive of the EBM Claim Processing Listener is to pay claims as quickly as possible and, in some embodiments, anything that does not affect payment (e.g., labeling) is deferred to a later time. In some embodiments, the EBM Claim Processing Listener is responsible for identifying the active EBM program, qualifying the claim for accumulations, and calculating a possible reduced payment. The Complete Goal Message Listener shown in FIG. 5 is a module that wraps up evaluation of an EBM program for a claim. In some embodiments, the Complete Goal Message Listener is responsible for issuing timeline events when outcomes are achieved, updating accumulations, and preparing deferred outcomes for execution. The Event Transaction Message Listener shown in FIG. 5 is a module that executes deferred outcomes. The Batch Reconciler shown in FIG. 5 is a module that rebuilds accumulators for when Claims Processing alters payment after the EBM response. The Batch Service Planner shown in FIG. 5 is a module that updates the communication contract between Claims Processing and the EBM Claim Processing Listener. In some embodiments, as EBM programs are associated to new Offers (e.g., member populations) or reconfigured, the planner adjusts parameters so Claims Processing can optimally bypass EBM for non-participating claims. In some embodiments, Configuration Management provides the user front-end to maintain Offers and EBM programs. In some embodiments, an AMP Logic Engine is the beholder of all transactional business logic for Adjudicated Marketing Programs.

In some embodiments, Action is the design equivalent of an Outcome. In some embodiments, Event Reactor is the systematic triggering of Actions, which could trigger more Events, which could trigger more Actions, and so forth. In some embodiments, Goal is the design equivalent of an EBM program's Event, or rule set. In some embodiments, Goal Plan is the design equivalent of an EBM program. In some embodiments, Participation is the design equivalent of a Member's accumulation set and, in some embodiments, participation continues until an Outcome is achieved, or is cancelled by the administrator.

In some embodiments, EBM can be used to incentivize course completion for certain disease states. In some embodiments, an objective in incentivizing course completion for certain disease states is to award reduced or waived copay to members with one or more high-risk conditions (e.g., hypertension, diabetes, high cholesterol, obesity, and the like, and combinations thereof) that complete a behavior modification course (e.g., healthier living, stress reduction, nutrition counseling, and the like). In some embodiments, the acts to accomplish this objective include one or more of the following:
(1) Label members with paid scripts for one or more chronic conditions (e.g., as identified by prescriptions submitted for medications associated with a certain condition).
(2) Communicate details regarding a behavior modification course and its associated incentive.
(3) Import external feed at regular intervals. A variety of file types are acceptable (e.g., text files, Excel, and the like) and, in some embodiments, include the member ID and indicator. The indicator can be a Y/N flag or a code that indicates more detailed results. If real time upload is desired, a web service (e.g., an Argus Health Systems, Inc. web service) can be used.
(4) Attach an EBM configuration to the customer/client/group that will execute a reduced or waived copay outcome for members that have successfully completed the course.

In some embodiments, EBM can be used to incentivize diabetic monitoring. In some embodiments, an objective in incentivizing diabetic monitoring is to award reduced or waived copay to diabetic members who adhere to a baseline blood sugar testing schedule on a regular basis. In some embodiments, the acts to accomplish this objective include one or more of the following:
(1) Label members with paid scripts for diabetic medications (e.g., insulin).
(2) Establish a baseline testing schedule (e.g., twice per day) and a method of upload for patient self-reporting.
(3) Import external feed at regular intervals. A variety of file types are acceptable (e.g., text files, Excel, and the like) and, in some embodiments, include the member ID and indicator. If real time upload is desired, a web service (e.g., an Argus Health Systems, Inc. web service) can be used.
(4) Attach an EBM configuration to the customer/client/group that will execute a reduced or waived copay outcome for members that meet the baseline testing criteria over some time period.

In some embodiments, EBM can be used to incentivize a switch from a brand-name drug to a generic equivalent. In some embodiments, an objective in incentivizing a switch from a brand-name drug to a generic equivalent is to award reduced or waived copay to members who convert to Generic Drug A from Brand-Name Drug B without having previously filled script for the Generic Drug A. In some embodiments, the acts to accomplish this objective include one or more of the following:
(1) Identify members who have paid claims for Brand-Name Drug B in the last n months, and who have not also filled scripts for Generic Drug A (e.g., using the suite of services marketed under the trade name TARGETED INTERVENTION STRATEGIES™ by Argus Health Systems, Inc.). Produce a file extract for these members. In some embodiments, TARGETED INTERVENTION STRATEGIES™ is not used (e.g., if the award is granted for simply submitting a claim for Generic Drug A). In some embodiments (e.g., ones having a “look back” component), TARGETED INTERVENTION STRATEGIES™ and the application of labels can be used.
(2) Apply member labels to members identified in (1).
(3) Attach an EBM configuration to the customer/client/group (offer) that will execute a reduced or waived copay outcome for members with the brand label.

In some embodiments, EBM can be used to incentivize a switch from a retail pharmacy to a mail order pharmacy. In some embodiments, an objective in incentivizing a switch from a retail pharmacy to a mail order pharmacy is to award reduced or waived copay to members who have previously paid claims for select drugs at 90 days through a retail pharmacy when they fill a script for the same drug at a select mail order pharmacy. In some embodiments, the acts to accomplish this objective include one or more of the following:
(1) Perform member identification and letter generation to targeted members using, in some embodiments, TARGETED INTERVENTION STRATEGIES™. Produce a file extract for these members. In some embodiments, TARGETED INTERVENTION STRATEGIES™ is not used (e.g., if the award is granted for simply submitting a 90-day claim through a specific mail order pharmacy). In some embodiments (e.g., ones having a “look back” component), TARGETED INTERVENTION STRATEGIES™ and the application of labels can be used.
(2) Apply member labels to members identified in (1).
(3) Attach an EBM configuration to the customer/client/group (offer) that will execute a reduced or waived copay outcome for members with the label.

In some embodiments, EBM can be used to incentivize medical therapy compliance for diabetic patients. In some embodiments, an objective in incentivizing medical therapy compliance for diabetic patients is to award reduced or waived copay to diabetic members when they submit a claim for a generic blood pressure medication if they are not already taking that medication. In some embodiments, the acts to accomplish this objective include one or more of the following:
(1) Identify members who are diabetic (e.g., have paid claims for insulin) and have no previous claims for any of the targeted generic blood pressure medications (e.g., using TARGETED INTERVENTION STRATEGIES™). Produce a file extract for these members. In some embodiments, TARGETED INTERVENTION STRATEGIES™ is not used (e.g., if the award is granted for simply submitting a claim for a generic blood pressure medication). In some embodiments (e.g., ones having a “look back” component), TARGETED INTERVENTION STRATEGIES™ and the application of labels can be used.
(2) Apply member labels to members identified in (1).
(3) Attach an EBM configuration to the customer/client/group (offer) that will execute a reduced/waived copay outcome for members who have the label.

In contrast to current functionality in which a member is assigned 100% payment rather than denial, an EBM enhancement can be used to deny claims as further described below. In some embodiments, EBM can be used to implement monthly script limits. In some embodiments, an objective in implementing monthly script limits is to limit the number of scripts for non-maintenance drugs and deny any claims over the threshold. In some embodiments, the acts to accomplish this objective include one or more of the following:
(1) Attach an EBM configuration to the member population to which this program applies. Begin tracking all non-maintenance drugs for each member beginning at midnight on the first day of the month.
(2) Deny all scripts submitted after the maximum number has been met.
(3) Reset accumulators at midnight on the last day of the month.

In some embodiments, EBM can be used to incentivize a switch from brand-name drug to non-corresponding generic drug in the same class. In some embodiments, an objective in incentivizing a switch from a brand-name drug to a non-corresponding generic drug in the same class is to award reduced or waived copay to members who have previously taken Brand-Name Drug X when they submit a claim for a generic drug in the same class. In some embodiments, the acts to accomplish this objective include one or more of the following:
(1) Identify members who have a paid claim for Brand Drug X in the last n months (e.g., using the TARGETED INTERVENTION STRATEGIES™) and produce a file extract. In some embodiments, TARGETED INTERVENTION STRATEGIES™ is not used (e.g., if the award is granted for simply submitting a claim for the generic drug in a specific class). In some embodiments (e.g., ones having a “look back” component), TARGETED INTERVENTION STRATEGIES™ and the application of labels can be used.
(2) Apply member labels to members identified in (1).
(3) Attach an EBM configuration to the customer/client/group (offer) that will execute a reduced or waived copay outcome for members with the brand label when they submit a claim for a generic drug identified in EBM by the class.

In some embodiments, EBM can be used to incentivize adherence to a medication regime. In some embodiments, an objective in incentivizing adherence to a medication regime is to award reduced or waived copay in connection with select scripts for select drugs. By way of non-limiting and representative example, in some embodiments, the copay for every third script that a member submits for blood pressure medication can be reduced or waived. In some embodiments, the acts to accomplish this objective include one or more of the following:
(1) Identify members who have a paid claim for Drug X in the last n months (e.g., using TARGETED INTERVENTION STRATEGIES™) and produce a file extract. In some embodiments, TARGETED INTERVENTION STRATEGIES™ is not used (e.g., if the award is granted for simply submitting a claim for the particular drug at some interval). In some embodiments (e.g., ones having a “look back” component), TARGETED INTERVENTION STRATEGIES™ and the application of labels can be used.
(2) Apply member labels to members identified in (1).
(3) Attach an EBM configuration to the member population that will execute a reduced or waived copay outcome for members with the drug label when they submit a claim for that drug at a specified frequency.

In some embodiments, EBM can be used to incentivize timely adherence to a medication regime. In some embodiments, an objective in incentivizing timely adherence to a medication regime is to award reduced or waived copay to patients who fill their scripts for select medications on a timely basis. By way of non-limiting and representative example, in some embodiments, the copay can be reduced by $5 when a patient refills a script for blood pressure medication within 35 days, or reduced by $10 if the patient refills the script within 30 days. In some embodiments, the acts to accomplish this objective include one or more of the following:
(1) Identify members who have a paid claim for Drug X in the last n months (e.g., using TARGETED INTERVENTION STRATEGIES™) and produce a file extract. In some embodiments, TARGETED INTERVENTION STRATEGIES™ is not used (e.g., if the award is granted for simply submitting a claim for the particular drug at some interval). In some embodiments (e.g., ones having a “look back” component), TARGETED INTERVENTION STRATEGIES™ and the application of labels can be used.
(2) Apply member labels to members identified in (1).
(3) Attach an EBM configuration to the member population that will execute a reduced or waived copay outcome for members with the drug label when they submit a claim for that drug within the designated time period.

In some embodiments, a representative and non-limiting outline for EBM online processing is as shown in Table 1 below.

TABLE 1
Online Processing

| 1. | Receive claim from pharmacy. | |
|---|---|---|
| 2. | Start CICS transaction. | |
| 3. | Determine whether to use EBM: | |
| | 3.1. | Evaluate flags that signal EBM program is active for a particular |
| | | member population. If no active program, skip to #17. |
| 4. | Start claim transaction: | |
| | 4.1. | Create new record in AMP CLAIM TRANSACTION table. |
| 5. | Select EBM program: | |
| | 5.1. | Fetch the Member Population Identifier based on CLAIM and |
| | | MEMBER. If none, skip to #17. |
| | 5.2. | Fetch the EBM Rule Set that is active for the MARKETING |
| | | OFFER (EBM program). If none, skip to #17. |
| 6. | Start JDBC transaction. | |
| 7. | Select patient: | |
| | 7.1. | Fetch the PROSPECT (patient) owning the MEMBER (this is to |
| | | see if the patient already exists as a member). If none exists |
| | | and EBM program specifies creating-on-demand: |

| | |
|---|---|
| 7.1.1. | Insert new record into CONSUMER database (add |
| | patient record). |
| 7.1.2. | Insert into PROSPECT database (add patient record) |

| | 7.2. | If no PROSPECT, skip to #17. |
|---|---|---|
| 8. | Start event history: | |
| | 8.1. | Create new record in MARKETING EVENT TRANSACTION |
| | | table - indicates new claim. |
| | 8.2. | Create new record in MARKETING EVENT and CLAIM |
| | | MARKETING EVENT table - indicators that claim arrived for |
| | | particular rule set. |
| 9. | Select Rules to evaluate: | |
| | 9.1 | If the MARKETING GOAL PLAN REVISION COMPLETED |
| | | MARKETING EVENT exists for the goal plan revision, skip to |
| | | #14. This indicates that the rules have been met and there are |
| | | no further opportunities for outcomes. |
| | 9.2. | Fetch the MEMBER MARKETING GOAL REVISION |
| | | MARKETING GOAL PLAN REVISION for the MEMBER having |
| | | a CHANGE CLAIM MARKETING ACTION. Pull stats on the |
| | | member. |
| | 9.3. | Fetch all goal revisions from MARKETING GOAL PLAN |
| | | REVISION MARKETING GOAL REVISION that have a |
| | | CHANGE CLAIM MARKETING ACTION, and the count of |
| | | completed occurrences is less than the max occurrence of the |
| | | revision. Ensures that maximum number of outcomes has not |
| | | been met. |
| | 9.4. | Combine results. |
| 10. | Evaluate each goal against accumulators until first succeeds: | |
| | 10.1. | If accumulator-qualifying MARKETING GOAL CRITERIA fails |
| | | evaluation, skip goal. |
| | 10.2. | If no “open” one exists, insert into MEMBER MARKETING |
| | | GOAL REVISION. Associate member to the goal with the |
| | | iteration attempt. |
| | 10.3. | If outcome-qualifying MARKETING GOAL CRITERIA fails |
| | | evaluation, skip goal. |
| 11. | Calculate claim modification: | |
| | 11.1. | Update tables based on claim modification |

| | |
|---|---|
| 12. | Commit JDBC transaction. |
| 13. | Modify claim. |
| 14. | Send message to begin offline processing. |
| 15. | Insert three records into AMP CLAIM TRANSACTION SNAPSHOT. |
| 16. | Respond to pharmacy. |
| 17. | Commit CICS transaction. |

Table 2 below shows a representative and non-limiting outline of EBM offline processing for finishing goal plan evaluation.

TABLE 2
Offline Processing No. 1: Finish Goal Plan Evaluation

| 1. | Receive message identifying the CLAIM MARKETING EVENT, | |
|---|---|---|
| | MARKETING GOAL PLAN REVISION, and (if applicable) the recently | |
| | completed MEMBER MARKETING GOAL REVISION. View the | |
| | statuses. | |
| 2. | Start transaction. | |
| 3. | Verify response to the pharmacy: | |
| | 3.1. | If the AMP CLAIM TRANSACTION SNAPSHOT is found, skip to |
| | | #4. |
| | 3.2. | Delete the MARKETING EVENT TRANSACTION and cascade |
| | | to MARKETING EVENT and MARKETING EVENT |
| | | MARKETING ACTION. |
| | 3.3. | Skip to #8. |
| 4. | For each goal that is either the completed goal, or is incomplete and | |
| | has no CHANGE CLAIM MARKETING ACTION: | |
| | 4.1. | If outcome-qualifying MARKETING GOAL CRITERIA fails |
| | | evaluation, skip goal. |
| | 4.2. | For each outcome of the goal: |

| | |
|---|---|
| 4.2.1. | If outcome is CHANGE CLAIM MARKETING ACTION, |
| | skip outcome. |
| 4.2.2. | Add outcome to execution queue: Insert into |
| | MARKETING EVENT MARKETING ACTION without |
| | timestamps. |

| | 4.3. | Complete the MEMBER MARKETING GOAL REVISION. |
|---|---|---|
| | 4.4. | Insert into MEMBER MARKETING GOAL REVISION |
| | | COMPLETED MARKETING EVENT. |
| | 4.5. | If max occurrence is reached, insert into MARKETING GOAL |
| | | REVISION COMPLETED MARKETING EVENT. |
| | 4.6. | If the goal is exclusive to the MEMBER, delete it from MEMBER |
| | | MARKETING GOAL REVISION MARKETING GOAL PLAN |
| | | REVISION. |
| 5. | Evaluate configuration completion: | |
| | 5.1. | If any goal just completed and all goals maxed out, insert into |
| | | MARKETING GOAL PLAN COMPLETE EVENT. |
| 6. | Fetch the claim snapshot. | |
| 7. | Evaluate each goal: | |
| | 7.1. | If accumulator-qualifying MARKETING GOAL CRITERIA fails |
| | | evaluation, skip to next goal. |
| | 7.2. | Update accumulators. |

| | |
|---|---|
| 8. | Commit transaction. |

Table 3 below shows a representative and non-limiting outline of EBM offline processing for executing deferred actions.

TABLE 3
Offline Processing No. 2: Executed Deferred Actions

| 1. | Start transaction. | |
|---|---|---|
| 2. | Verify response to the pharmacy: | |
| | 2.1. | If the AMP CLAIM TRANSACTION SNAPSHOT is found, |
| | | skip to #3. |
| | 2.2. | Delete the MARKETING EVENT TRANSACTION and |
| | | cascade to MARKETING EVENT and MARKETING |
| | | EVENT MARKETING ACTION. |
| | 2.3. | Rollback accumulators. |
| | 2.4. | Skip to #5. |
| 3. | Execute deferred outcomes. | |
| 4. | End event history: | |
| | 4.1. | Update MARKETING EVENT TRANSACTION. |

| | |
|---|---|
| 5. | Commit transaction. |

In some embodiments, EBM programs are designed to promote patient compliance and persistency and, in some embodiments, these programs work with individual patient timelines and are designed to support patient segmentation. In some embodiments, EBM can track purchases to allow for refill reminders and/or provide critical touch points based on drop-off trends for products. In some embodiments, offers may include lifestyle coupons, other premiums, disease management tools, and/or the like, and combinations thereof. In some embodiments, these types of programs enable pharmaceutical companies to encourage patient health through, for example, providing access to medications without requiring payment of the entire cost of a drug. In some embodiments, the programs target new patients. In some embodiments, the programs target maintaining current patients. In some embodiments, the programs target new patients as well as maintaining current patients. In some embodiments, EBM programs are intended to promote brand loyalty and/or to encourage compliance and persistency.

A representative use case will now be described for purposes of illustrating aspects of the present teachings. In this representative use case, a claim that is being processed in claims processing is taken and evaluated for EBM, offer, and EBM configuration. A response is returned to claims processing. In some embodiments, the triggering actor is claims processing (e.g., a claim processing system). In some embodiments, other actors include an EBM system. In some embodiments, a pre-condition comprises a claim being received by claims processing.

In some embodiments, a basic flow of a representative use case is as shown in Table 4 below. The phrase “claim total cost” refers to the sum of the original member pay amount and the original plan pay amount that were on the claim when the claim was received in EBM from claims processing (original member pay amount+original plan pay amount). The phrase “remaining amount” refers to the sum of the original member pay amount and the original plan pay amount that were on the claim when the claim was received in EBM from claims processing (claim total cost) less the member pay amount to be included in the response to claims processing (claim total cost−the member pay amount to be included in the response to claims processing). The phrase “original member pay amount” refers to the member pay amount on the claim as submitted by claims processing. The phrase “original plan pay amount” refers to the plan pay amount on the claim as submitted by claims processing.

TABLE 4
Basic Flow of EBM Use Case

| 1. | The claims processing system determines that the claim should be | |
|---|---|---|
| | processed by EBM. [BR12, BR22] | |
| 2. | The claims processing system records a claim transaction for the claim. | |
| 3. | The claims processing system calls out to EBM processing. | |
| 4. | The system determines which offer is associated to the claim. [BR13, BR14] | |
| 5. | The system evaluates if the offer is active. [BR15] | |
| 6. | The system evaluates if the offer has an active EBM configuration. [BR16] | |
| 7. | The system determines that the claim is a point of sale claim. | |
| 8. | The system determines that there is at least one active event. [BR1] | |
| 9. | The system finds the member within the pharma database by matching | |
| | exactly on the member ID and offer. | |
| 10. | The system determines that there are no active open EBM member | |
| | outcome exceptions to process for this member. [BR8, BR9] | |
| 11. | For each active event in order of the processing order defined in the | |
| | EBM configuration: | |
| | a. | The system determines that the event has not been updated since |
| | | the last claim was received for the member. |
| | b. | The system determines the member's existing outcome count for the |
| | | event and the outcome maximum defined in the event. |
| | c. | The system determines that there is an open set for the member for |
| | | the event for the offer. |
| | d. | The system determines that the claim is not adjusted, updated, |
| | | reversed or deleted. |
| | e. | The system determines that an option to perform the strength |
| | | calculation is defined in the event (i.e. strength should be calculated |
| | | and accumulated to support titration). |
| | f. | The system calculates the claim strength. [BR19, BR20] |
| | g. | The system determines that there is an accumulation rule set. [BR2] |
| | h. | The system determines that the accumulation rule set is met by the |
| | | values associated with the claim or member. [BR3, BR17, BR18] |
| | i. | The system determines there is an outcome rule set. [BR4] |
| | j. | The system determines that the outcome rule set is met by the |
| | | values associated with the claim or member. [BR5, BR7, BR17, BR18] |
| | k. | The system determines that a claim outcome option is defined for |
| | | the event. |
| | l. | The system determines that while processing this claim sent by |
| | | claim processing this time that the member pay amount to be |
| | | included in the response to claims processing and the plan pay |
| | | amount to be included in the response to claims processing have not |
| | | been established by a previously processed event in this |
| | | configuration (i.e. a claim outcome did not occur previously while |
| | | looping through the events for this configuration for this claim |
| | | transaction). |
| | m. | The system determines that claims processing has not indicated that |
| | | the claim's copay amount was changed by a pre-auth (i.e. a pre-auth |
| | | did not override the claim's copay in claims processing). |
| | n. | The system determines that the member's existing plan pay |
| | | accumulation for the event is less than the plan pay accumulation |
| | | maximum value defined in the event (i.e. member is not over the |
| | | plan pay accumulation maximum). |
| | o. | The system determines that the claim outcome option defined in the |
| | | event is the member pays a flat dollar amount option. [BR17] |
| | p. | The system determines that the flat dollar amount value defined in |
| | | the event is less than or equal to the claim total cost. |
| | q. | The system determines that the flat dollar amount value defined in |
| | | the event is less than or equal to original member pay amount when |
| | | the claim was submitted to EBM. |
| | r. | The system defines the member pay amount to be included in the |
| | | response to claims processing to be the flat dollar amount value |
| | | defined in the event. |
| | s. | The system defines the plan pay amount to be included in the |
| | | response to claims processing to be the remaining amount. |
| | t. | The system determines that the plan pay amount to be included in |
| | | the response to claims processing is less than or equal to the per |
| | | claim plan max defined within the event (i.e. plan pay amount is not |
| | | over the per claim maximum). |
| | u. | The system defines the free-form message to be included in the |
| | | response to claims processing to be the free-form message defined |
| | | in the event. |
| | v. | The system applies the label names defined in the event for a |
| | | member to the claim's member. [BR6] |
| | w. | The system applies the label names defined in the event for a claim |
| | | to the claim. [BR6] |
| | x. | The system increments the outcome count by 1 for the member for |
| | | the event. |
| | y. | The system increments the claim count accumulation by 1 for the |
| | | open set for the member for the event for the offer. |
| | z. | The system records the claim's plan metric quantity in the |
| | | accumulation for the open set for the member for the event for the |
| | | offer. |
| | aa. | The system records the strength calculation in the accumulation for |
| | | the open set for the member for the event for the offer. |
| | bb. | The system records the member pay amount to be included in the |
| | | response to claims processing in the accumulation for the open set |
| | | for the member for the event for the offer. |
| | cc. | The system records the plan pay amount to be included in the |
| | | response to claims processing in the accumulation for the open set |
| | | for the member for the event for the offer. |
| | dd. | The system records the plan pay amount to be included in the |
| | | response to claims processing in the max plan pay accumulation for |
| | | the open set for the member for the event for the offer. |
| | ee. | The system changes the open set to a closed set. |
| | ff. | Return to step 11 for next event in the processing order. |

| | |
|---|---|
| 12. | The system determines that the member and plan pay amounts that |
| | were recorded within each applicable event's accumulations for this |
| | claim; do not require updates due to any additional event processing. |
| 13. | The system returns a response to claims processing with the values |
| | defined for the response for member pay amount, plan pay amount, |
| | and, if applicable, the free-form message. |
| 14. | The claims processing system receives a response from EBM. |
| 15. | The system records a pre-EBM claim snapshot. |
| 16. | The system records a post-EBM claim snapshot. |
| 17. | The claims processing system determines that the claim should |
| | continue with a status of pay. |
| 18. | The claims processing system determines that the claim total value is |
| | equal to the original claim total. |
| 19. | The claims processing system updates the member pay amount on |
| | the claim. |
| 20. | The claims processing system updates the plan pay amount on the |
| | claim. |
| 21. | The claims processing system adds the free form message to the |
| | claim. |
| 22. | The claims processing system continues to process the claim within |
| | standard claims processing. |
| 23. | The system records an EBM pharmacy claim snapshot. |

Exceptions to the basic flow outlined in Table 4 are shown in Table 5 below.

TABLE 5
Exception Flow(s) of EBM Use Case

| 3. | If the claims processing system determines that EBM is unavailable, | |
|---|---|---|
| | then | |
| | a. | The claims processing system sets the following denial codes. |
| | | NCPDP Error - Reject code 91, “Host Response Error” |
| | | and Argus Error - Call Pharm Help Desk. |
| | b. | Use Case Ends. |
| 9. | If the system does not find the member in the pharma database, then: | |
| | a. | If the system determines that the offer has an option |
| | | defined to not add the member on a claim to the consumer |
| | | database if the member is not found during EBM processing |
| | | or no option is defined at all, then: |
| | b. | The system sets the following denial codes. NCPDP |
| | | Error - Reject code M6, “Host Eligibility Error” |
| | | and Argus Error - Register Pharmhelp. |
| | c. | Use Case Ends. |
| 18. | If the claims processing system determines that the claim | |
| | total value is not equal to the original claim total. | |
| | a. | The claims processing system sets the following denial codes. |
| | | NCPDP Error - Reject code 91, “Host Response Error” |
| | | and Argus Error - Error-Call Pharma Help Desk. |
| | b. | Use Case Ends. |

Alternate flows for the representative use case are shown in Table 6 below. In some embodiments, a post-condition comprises a claim processing with an updated EBM-calculated member and plan pay amount—with or without a free-form message. In some embodiments, labels may be applied to the member and/or the claim, and accumulations are updated. In some embodiments, these results do not occur every time with variances described in the alternate flows shown in Table 6.

TABLE 6
Alternate Flow(s) in EBM Use Case

| 1. | If the claims processing system determines that the claim | |
|---|---|---|
| | should not be processed by EBM, then resume basic flow at | |
| | step 22. | |
| 4. | If the claim does not match an offer, then resume basic flow | |
| | at step 22. | |
| 5. | If the claim does not match an active offer, then resume | |
| | basic flow at step 22. | |
| 6. | If the active offer does not include an active EBM | |
| | configuration, then resume basic flow at step 22. | |
| 7. | If the system determines that the claim is not a point of sale | |
| | claim. | |
| | a. | The system defines the member pay amount to be |
| | | included in the response to claims processing to be the |
| | | original member pay amount. |
| | b. | The system defines the plan pay amount to be included |
| | | in the response to claims processing to be the original |
| | | plan pay amount. |
| | c. | The system does not set a free-form message to be |
| | | included in the response to claims processing. |
| | d. | Resume basic flow at step 13. |
| 8. | If the system does not find any active events within the | |
| | Configuration, then: | |
| | a. | The system defines the member pay amount to be |
| | | included in the response to claims processing to be the |
| | | original member pay amount. |
| | b. | The system defines the plan pay amount to be included |
| | | in the response to claims processing to be the original |
| | | plan pay amount. |
| | c. | The system does not set a free-form message to be |
| | | included in the response to claims processing. |
| | d. | Resume basic flow at step 13. |
| 9. | If the system does not find the member in the pharma | |
| | database, then: | |
| | a. | If the system determines that the claim received is an |
| | | adjusted, updated, reversed or deleted claim, resume |
| | | basic flow at step 13. |
| | b. | If the system determines that the offer has an option |
| | | defined to add the member on a claim to the |
| | | consumer database if the member is not found during |
| | | EBM processing, then the system adds the member to |
| | | the consumer database. UC Add Consumer from |
| | | EBM Processing. Resume basic flow at step 10. |
| 10. | If the system determines that there is an active EBM | |
| | member outcome exception to process for this member | |
| | then, | |
| | a. | The system determines that the claim is not adjusted, |
| | | updated, reversed or deleted. |

| | |
|---|---|
| 1. | If the claim is adjusted, updated, reversed or |
| | deleted, resume basic flow at step 11. |

| | |
|---|---|
| b. | The system determines there is a qualification rule |
| | set. [BR10] |

| | |
|---|---|
| 1. | If there is not a qualification rule set, then resume |
| | alternate flow at step 10d. |

| | |
|---|---|
| c. | The system determines that the qualification rule set |
| | is met by the values associated with the claim or |
| | member. [BR11] [BR17] |
| d. | The system determines that a claim outcome option is |
| | defined for the event. |
| e. | The system determines that claims processing has |
| | not indicated that the claim's copay amount was |
| | changed by a pre-auth (i.e. a pre-auth did not override |
| | the claim's copay in claims processing). |

| | |
|---|---|
| 1. | If the system determines that claims processing |
| | has indicated that the claim's copay amount was |
| | changed by a pre-auth, resume basic flow at step |
| | 11ff. |

| | f. | Resume basic flow at step 11o. |
|---|---|---|
| 11.a. | If the system determines that the event has been updated | |
| | since the last claim was received and there is not an | |
| | open set and there is not an orphaned set for the member | |
| | for the event for the offer, then resume basic flow at step | |
| | 11.b. | |
| 11.a. | If the system determines that the event has been updated | |
| | since the last claim was received and there is an open | |
| | set, then: | |
| | a. | If an option to close both open and orphaned sets is |
| | | not defined in the event, then resume basic flow at |
| | | step 11.b. (i.e. The member will continue to get credit |
| | | for the open set after the event is updated.) |
| | b. | If an option to close both open and orphaned sets is |
| | | defined in the event, then change the open set to a |
| | | closed set (i.e. The member will not get credit for an |
| | | open set after the event is updated.). |

| | |
|---|---|
| 1. | The system resets the Member Pay Accumulation |
| | to zero. |
| 2. | The system resets the Plan Pay Accumulation to |
| | zero. |
| 3. | The system resets the Claim Count Accumulation |
| | to zero. |
| 4. | If present, the system resets the Calculated |
| | Strength Accumulation to zero |
| 5. | The system resets the Quantity Accumulation to |
| | zero. |
| 6. | Resume basic flow at step 11.b. |

| 11.a. | If the system determines that the event has been updated | |
|---|---|---|
| | since the last claim was received and there is an | |
| | orphaned set, then: | |
| | a. | If an option to close both open and orphaned sets is |
| | | not defined for the event and an option to close only |
| | | orphaned sets is not defined for the event, then |
| | | change the orphaned set into an open set (i.e. The |
| | | member will get a one-time credit for the claims in the |
| | | orphaned set after an event is updated.). Resume |
| | | basic flow at step 11.b. |
| | b. | If an option to close both open and orphaned sets is |
| | | defined for the event or an option to close only |
| | | orphaned sets is defined for the event, then change |
| | | the orphaned set to a closed set (i.e. The member will |
| | | not get credit for the claims in the orphaned set after |
| | | an event is updated). |

| | |
|---|---|
| 1. | The system resets the Member Pay Accumulation |
| | to zero. |
| 2. | The system resets the Plan Pay Accumulation to |
| | zero. |
| 3. | The system resets the Claim Count Accumulation |
| | to zero. |
| 4. | If present, the system resets the Calculated |
| | Strength Accumulation to zero. |
| 5. | The system resets the Quantity Accumulation to |
| | zero. |
| 6. | Resume basic flow at step 11.b. |

| 11.c. | If the system determines that there is not an open set for | |
|---|---|---|
| | the member for the event for the offer, then: | |
| | a. | If the system determined that the member's existing |
| | | outcome count for the event is less than the outcome |
| | | maximum defined in the event (i.e. member has not |
| | | yet met the maximum outcome), then: |

| | |
|---|---|
| i. | If there is an orphaned set for the member for the |
| | event for the offer, then change the orphaned set |
| | to an open set. Resume basic flow at step 11.d. |
| ii. | If there is no orphaned set for the member for the |
| | event for the offer, then the system creates an |
| | open set with zero accumulations. Resume basic |
| | flow at step 11.d. |

| | |
|---|---|
| b. | If the system determined that the member's existing |
| | outcome count for the event is equal to or greater than |
| | the outcome maximum defined in the event (i.e. |
| | member has met the maximum outcome), then: |

| | |
|---|---|
| i. | If there is an orphaned set for the member for the |
| | event for the offer, then resume basic flow at step |
| | 11.d. |
| ii. | If there is no orphaned set for the member for the |
| | event for the offer, then the system creates an |
| | orphaned set with zero accumulations. Resume |
| | basic flow at step 11.d. |

| 11.c. | If the system determined that the member's existing | |
|---|---|---|
| | outcome count for the event is equal to or greater than | |
| | the outcome maximum defined in the event (i.e. member | |
| | has met the maximum outcome), then the system | |
| | changes the open set to an orphaned set. Resume basic | |
| | flow at step 11.d. | |
| 11.d. | If the system determines that the claim is adjusted, | |
| | updated, reversed or deleted and the claim as it was last | |
| | received is part of a closed set for the member for the | |
| | event for the offer, then: | |
| | a. | The system removes the plan pay amount from the |
| | | max plan pay accumulation that exists for the claim as |
| | | it was last received, for the member for the event for |
| | | the offer. |
| | b. | If the claim is an adjusted or updated claim and the |
| | | system determines that there is an accumulation rule |
| | | set and the accumulation rule set is met by the values |
| | | associated with the claim or member, the system adds |
| | | the plan pay amount to the max plan pay |
| | | accumulation that exists for the member for the event |
| | | for the offer. [BR2, BR3, BR17, BR18] |
| | c. | If the claim is an adjusted or updated claim and the |
| | | system determines that there is no accumulation rule |
| | | set, the system adds the plan pay amount to the max |
| | | plan pay accumulation that exists for the member for |
| | | the event for the offer. [BR2, BR3, BR17, BR18] |
| | d. | If the claim is an adjusted or updated claim return to |
| | | basic flow step 11ff. |
| | e. | If the claim is reversed or deleted, then; |

| | |
|---|---|
| 1. | The system defines the member pay amount to be |
| | included in the response to claims processing to |
| | be the original member pay amount. |
| 2. | The system defines the plan pay amount to be |
| | included in the response to claims processing to |
| | be the original plan pay amount. |
| 3. | The system does not set a free-form message to |
| | be included in the response to claims processing. |
| 4. | Resume basic flow at step 11.ff. |

| | |
|---|---|
| d. | The system determines that while processing this |
| | claim sent by claim processing this time that the |
| | member pay amount to be included in the response to |
| | claims processing and the plan pay amount to be |
| | included in the response to claims processing have |
| | already been established by a previously processed |
| | event in this configuration. |

| | |
|---|---|
| 1. | Resume basic flow at step 11.ff. |

| 11.d. | If the system determines that the claim is adjusted, | |
|---|---|---|
| | updated, reversed or deleted and the claim as it was last | |
| | received is part of an orphaned set for the member for the | |
| | event for the offer, then: | |
| | a. | The system reduces the claim count by 1 in the |
| | | orphaned set for the claim as it was last received, for |
| | | the member for the event for the offer from the |
| | | accumulation set. |
| | b. | The system removes the quantity amount that |
| | | currently exists in the orphaned set for the claim as it |
| | | was last received, for the member for the event for the |
| | | offer from the accumulation set. |
| | c. | If present, the system removes the strength amount |
| | | that currently exists in the orphaned set for the claim |
| | | as it was last received, for the member for the event |
| | | for the offer from the accumulation set. |
| | d. | The system removes the member pay amount that |
| | | currently exists in the orphaned set for the claim as it |
| | | was last received, for the member for the event for the |
| | | offer from the accumulation set. |
| | e. | The system removes the plan pay amount that |
| | | currently exists in the orphaned set for the claim as it |
| | | was last received, for the member for the event for the |
| | | offer from the accumulation set. |
| | f. | The system removes the max plan pay accumulation |
| | | that exists for the claim as it was last received, for the |
| | | member for the event for the offer. If the claim is |
| | | adjusted or updated, resume basic flow at step 11.g. |
| | g. | If the claim is reversed or deleted, then; |

| | |
|---|---|
| i. | The system defines the member pay amount to be |
| | included in the response to claims processing to |
| | be the original member pay amount. |
| ii. | The system defines the plan pay amount to be |
| | included in the response to claims processing to |
| | be the original plan pay amount. |
| iii. | The system does not set a free-form message to |
| | be included in the response to claims processing. |
| iv. | Resume basic flow at step 11.ff. |

Note: If a Member Accumulation Exception has been saved for
a member after a claim has been processed for that member,
but prior to the same claim being adjusted, updated, reversed or
deleted, the accumulation value or values that were entered
within the Exception are absolute values, and will not be
adjusted based on the adjusted, updated, reversed or deleted
claim.

| 11.d. | If the system determines that the claim is adjusted, | |
|---|---|---|
| | updated, reversed or deleted and the claim as it was last | |
| | received is part of an open set for the member for the | |
| | event for the offer, then: | |
| | a. | The system reduces the claim count by 1 in the open |
| | | set for the claim for the member for the event for the |
| | | offer from the accumulation set. |
| | b. | The system removes the quantity amount that |
| | | currently exists in the open set for the claim as it was |
| | | last received, for the member for the event for the |
| | | offer from the accumulation set. |
| | c. | If present, the system removes the strength amount |
| | | that currently exists in the open set for the claim as it |
| | | was last received, for the member for the event for the |
| | | offer from the accumulation set. |
| | d. | The system removes the member pay amount that |
| | | currently exists in the open set for the claim as it was |
| | | last received, for the member for the event for the |
| | | offer from the accumulation set. |
| | e. | The system removes the plan pay amount that |
| | | currently exists in the open set for the claim as it was |
| | | last received, for the member for the event for the |
| | | offer from the accumulation set. |
| | f. | The system removes the max plan pay accumulation |
| | | that exists for the claim as it was last received, for the |
| | | member for the event for the offer. |
| | g. | If the claim is adjusted or updated, resume basic flow |
| | | at step 11.g. |
| | h. | If the claim is reversed or deleted, then; |

| | |
|---|---|
| i. | The system defines the member pay amount to be |
| | included in the response to claims processing to |
| | be the original member pay amount. |
| ii. | The system defines the plan pay amount to be |
| | included in the response to claims processing to |
| | be the original plan pay amount. |
| iii. | The system does not set a free-form message to |
| | be included in the response to claims processing. |
| iv. | Resume basic flow at step 11.ff. |

Note: If a Member Accumulation Exception has been saved for
a member after a claim has been processed for that member,
but prior to the same claim being adjusted, updated, reversed or
deleted, the accumulation value or values that were entered
within the Exception are absolute values, and will not be
adjusted based on the adjusted, updated, reversed or deleted
claim.

| 11.d. | If the system determines that the claim is adjusted, | |
|---|---|---|
| | updated, reversed or deleted and the claim as it was last | |
| | received is not found for the member for the event for the | |
| | offer, then: | |
| | a. | The system determines that while processing this |
| | | claim sent by claim processing this time that the |
| | | member pay amount to be included in the response to |
| | | claims processing and the plan pay amount to be |
| | | included in the response to claims processing have |
| | | not been established by a previously processed event |
| | | in this configuration. |

| | |
|---|---|
| 1. | The system defines the member pay amount to |
| | be included in the response to claims |
| | processing to be the original member pay |
| | amount. |
| 2. | The system defines the plan pay amount to be |
| | included in the response to claims processing |
| | to be the original plan pay amount. |
| 3. | The system does not set a free-form message |
| | to be included in the response to claims |
| | processing. |
| 4. | Resume basic flow at step 11.ff. |

| | |
|---|---|
| b. | The system determines that while processing this |
| | claim sent by claim processing this time that the |
| | member pay amount to be included in the response to |
| | claims processing and the plan pay amount to be |
| | included in the response to claims processing have |
| | already been established by a previously processed |
| | event in this configuration. |

| | |
|---|---|
| 1. | Resume basic flow at step 11.ff. |

| 11.g. | If the system determines there is no accumulation rule set | |
|---|---|---|
| | for the event, then resume basic flow at step 11.i. | |
| 11.h. | If the system determines that the values associated with | |
| | the claim do not match the accumulation rule set for the | |
| | event, then resume basic flow at step 11.ff. | |
| 11.j. | If the outcome rule set is not met by the values | |
| | associated with the claim and the existing accumulations | |
| | for the member for the event for the offer, then resume | |
| | basic flow at step 11.y. | |
| 11.k. | If the system determines that a claim outcome option is | |
| | not defined for the event, then resume basic flow at step | |
| | 11.v. | |
| 11.i. | If the system determined that the member's existing | |
| | outcome count for the event is equal to or greater than | |
| | the outcome maximum value defined in the event (i.e. the | |
| | member has met the maximum outcome), then resume | |
| | basic flow at step 11.y. | |
| 11.l. | If the system determines that a claim outcome has | |
| | already been received for the claim by a previously | |
| | processed event, then resume basic flow at step 11.y. | |
| 11.m. | If the system determines that claims processing has | |
| | indicated that the claim's copay amount was changed by | |
| | a pre-auth, then resume basic flow at step 11.y. | |
| 11.n. | If the system determines that the member's existing plan | |
| | pay accumulation for the event is equal to or greater than | |
| | the plan pay accumulation maximum value defined in the | |
| | event (i.e. member has met the plan pay accumulation | |
| | maximum). | |
| | a. | The system defines the member pay amount to be |
| | | included in the response to claims processing to be |
| | | the original member pay amount. |
| | b. | The system defines the plan pay amount to be |
| | | included in the response to claims processing to be |
| | | the original plan pay amount. |
| | c. | Resume basic flow at step 11.y. |
| 11.o. | If the system determines that the claim outcome option is | |
| | the member pays a flat dollar amount plus the sales tax | |
| | option, then: | |
| | a. | If the system determines that the sum of the flat dollar |
| | | amount value defined in the event and the claim's |
| | | plan sales tax is less than or equal to the claim total |
| | | cost ((flat dollar amount value + claim's plan sales tax) |
| | | <= claim total cost), then: |

| | |
|---|---|
| i. | If the system determines that the flat dollar amount |
| | value defined in the event is less than or equal to |
| | the claim's original member pay amount (flat dollar |
| | amount value <= original member pay amount), |
| | then: |

| | |
|---|---|
| 1. | The system defines the member pay amount to |
| | be included in the response to claims |
| | processing to be the sum of the flat dollar |
| | amount value defined in the event and the |
| | claim's plan sales tax (flat dollar amount value + |
| | claim's plan sales tax). |
| 2. | The system defines the plan pay amount to be |
| | included in the response to claims processing |
| | to be the remaining amount. |
| 3. | Resume basic flow at step 11.t. |

| | |
|---|---|
| ii. | If the system determines that the flat dollar amount |
| | value defined in the event is greater than the |
| | claim's original member pay amount (flat dollar |
| | amount value > original member pay amount), |
| | then: |

| | |
|---|---|
| 1. | The system defines the member pay amount to |
| | be included in the response to claims |
| | processing to be the sum of the original |
| | member pay amount and the claim's plan sales |
| | tax (original member pay amount + claim's plan |
| | sales tax). |
| 2. | The system defines the plan pay amount to be |
| | included in the response to claims processing |
| | to be the remaining amount. |
| 3. | Resume basic flow at step 11.t. |

| | |
|---|---|
| b. | If the system determines that the sum of the flat dollar |
| | amount value defined in the event and the claim's |
| | plan sales tax is greater than the claim total cost ((flat |
| | dollar amount value + claim's plan sales tax) > claim |
| | total cost), then: |

| | |
|---|---|
| i. | The system defines the member pay amount to be |
| | included in the response to claims processing to |
| | be the original member pay amount. |
| ii. | The system defines the plan pay amount to be |
| | included in the response to claims processing to |
| | be the original plan pay amount. |
| iii. | Resume basic flow at step 11.t. |

| 11.o. | If the system determines that the claim outcome option is | |
|---|---|---|
| | the member pays the remainder after a dollar amount off | |
| | option, then: | |
| | a. | If the system determines that the dollar amount off |
| | | value defined in the event is less than or equal to the |
| | | claim total cost (dollar amount off value <= claim total |
| | | cost), then: |

| | |
|---|---|
| i. | If the system determines that the dollar amount off |
| | value defined in the event is less than or equal to |
| | the claim's original member pay amount (dollar |
| | amount off value <= original member pay amount), |
| | then: |

| | |
|---|---|
| 1. | The system defines the member pay amount to |
| | be included in the response to claims |
| | processing to be the original member pay |
| | amount less the dollar amount off value defined |
| | in the event (original member pay amount − |
| | dollar amount off value). |
| 2. | The system defines the plan pay amount to be |
| | included in the response to claims processing |
| | to be the remaining amount. |
| 3. | Resume basic flow at step 11.t. |

| | |
|---|---|
| ii. | If the system determines that the dollar amount off |
| | value defined in the event is greater than the |
| | claim's original member pay amount (dollar |
| | amount off value > original member pay amount), |
| | then: |

| | |
|---|---|
| 1. | The system defines the member pay amount to |
| | be included in the response to claims |
| | processing to be zero. |
| 2. | The system defines the plan pay amount to be |
| | included in the response to claims processing |
| | to be the claim total cost. |
| 3. | Resume basic flow at step 11.t. |

| | |
|---|---|
| b. | If the system determines that the dollar amount off |
| | value defined in the event is greater than the claim |
| | total cost (dollar amount off value > claim total cost), |
| | then: |

| | |
|---|---|
| i. | The system defines the member pay amount to be |
| | included in the response to claims processing |
| | equal zero. |
| ii. | The system defines the plan pay amount to be |
| | included in the response to claims processing to |
| | be the claim total cost. |
| iii. | Resume basic flow at step 11.t. |

| 11.o. | If the system determines that the claim outcome option is | |
|---|---|---|
| | the member pays the remainder after a dollar amount off | |
| | plus sales tax option, then: | |
| | a. | If the system determines that the dollar amount off |
| | | value defined in the event and the claim's plan sales |
| | | tax is less than or equal to the claim total cost ((dollar |
| | | amount off value + claim's plan sales tax) <= claim |
| | | total cost), then: |

| | |
|---|---|
| i. | If the system determines that the dollar amount off |
| | value defined in the event is less than or equal to |
| | the claim's original member pay amount (dollar off |
| | amount <= original member pay amount), then: |
| ii. | the system defines the member pay amount to be |
| | included in the response to claims processing to |
| | be the original member pay amount less the |
| | difference of dollar amount off value defined in the |
| | event and the claim's plan sales tax (original |
| | member pay amount − (dollar amount off value) + |
| | claim's plan sales tax)). |
| iii. | The system defines the plan pay amount to be |
| | included in the response to claims processing to |
| | be the remaining amount. |
| iv. | Resume basic flow at step 11.t. |

| | |
|---|---|
| b. | If the system determines that the dollar amount off |
| | value defined in the event is greater than the claim's |
| | original member pay amount (dollar amount off value |
| | >original member pay amount), then: |

| | |
|---|---|
| i. | The system defines the member pay amount to be |
| | included in the response to claims processing to |
| | be the claim's plan sales tax. |
| ii. | The system defines the plan pay amount to be |
| | included in the response to claims processing to |
| | be the remaining amount. |
| iii. | Resume basic flow at step 11.t. |

| | |
|---|---|
| c. | If the system determines that the dollar amount off |
| | value defined in the event is greater than the claim |
| | total cost (dollar amount off value >claim total cost), |
| | then: |

| | |
|---|---|
| i. | The system defines the member pay amount to be |
| | included in the response to claims processing to |
| | be the claim's plan sales tax. |
| ii. | The system defines the plan pay amount to be |
| | included in the response to claims processing to |
| | be the remaining amount. |
| iii. | Resume basic flow at step 11.t. |

| 11.o. | If the system determines that the claim outcome option is | |
|---|---|---|
| | the member pays a percentage of the original member | |
| | pay amount, then: | |
| | a. | The system calculates the percentage of amount by |
| | | multiplying the original member pay amount by the |
| | | percentage of value defined in the event (original |
| | | member pay amount * percentage of value). |

| | |
|---|---|
| i. | If the percentage of amount calculation results in |
| | an amount with partial pennies, then the system |
| | rounds down the percentage of amount to the next |
| | cent. For example, if the original member pay |
| | amount is $201.29 and the percentage of value |
| | defined in the event is 10%, then the calculation |
| | result would be $20.129 (201.29 * .10); the system |
| | would round the result down to $20.12. |

| | |
|---|---|
| b. | If the system determines that the calculated |
| | percentage of amount is less than or equal to the |
| | claim total cost (calculated percentage of amount <= |
| | claim total cost), then: |
| c. | If the system determines that the calculated |
| | percentage of amount is less than or equal to the |
| | original member pay amount (calculated percentage |
| | of amount <= original member pay amount), then: |

| | |
|---|---|
| i. | The system defines the member pay amount to be |
| | included in the response to claims processing to |
| | be the calculated percentage of amount. |
| ii. | The system defines the plan pay amount to be |
| | included in the response to claims processing to |
| | be the remaining amount. |
| iii. | Resume basic flow at step 11.t. |

| | |
|---|---|
| d. | If the system determines that the calculated |
| | percentage of amount is greater than the claim's |
| | original member pay amount (calculated percentage |
| | of amount > original member pay amount), then: |

| | |
|---|---|
| i. | The system defines the member pay amount to be |
| | included in the response to claims processing to |
| | be the original member pay amount. |
| ii. | The system defines the plan pay amount to be |
| | included in the response to claims processing to |
| | be the original plan pay amount. |
| iii. | Resume basic flow at step 11.t. |

| | |
|---|---|
| e. | If the system determines that the calculated |
| | percentage of amount is greater than the claim total |
| | cost (calculated percentage of amount > claim total |
| | cost), then: |

| | |
|---|---|
| i. | The system defines the member pay amount to be |
| | included in the response to claims processing |
| | equal zero. |
| ii. | The system defines the plan pay amount to be |
| | included in the response to claims processing to |
| | be the claim total cost. |
| iii. | Resume basic flow at step 11.t. |

| 11.o. | If the system determines that the claim outcome option is | |
|---|---|---|
| | the member pays a percentage of the original member | |
| | pay amount plus the sales tax option, then: | |
| | a. | The system calculates the percentage of amount by |
| | | multiplying the original member pay amount by the |
| | | percentage of value defined in the event (original |
| | | member pay amount * percentage of value). |

| | |
|---|---|
| i. | If the percentage of amount calculation results in |
| | an amount with partial pennies, then the system |
| | rounds down the percentage of amount to the next |
| | cent. For example, if the original member pay |
| | amount is $201.29 and the percentage of value |
| | defined in the event is 10%, then the calculation |
| | result would be $20.129 (201.29 * .10); the system |
| | would round the result down to $20.12. |

| | |
|---|---|
| b. | If the system determines that the sum of the |
| | calculated percentage of amount and the claim's plan |
| | sales tax is less than or equal to the claim total cost |
| | ((calculated percentage of amount + claim's plan |
| | sales tax) <= claim total cost), then: |
| c. | If the system determines that the sum of the |
| | calculated percentage of amount and the claim's plan |
| | sales tax is less than or equal to the original member |
| | pay amount (calculated percentage of amount <= |
| | original member pay amount), then: |

| | |
|---|---|
| i. | The system defines the member pay amount to be |
| | included in the response to claims processing to |
| | be the sum of the calculated percentage of amount |
| | and the claim's plan sales tax (calculated |
| | percentage of amount + claim's plan sales tax). |
| ii. | The system defines the plan pay amount to be |
| | included in the response to claims processing to |
| | be the remaining amount. |
| iii. | Resume basic flow at step 11.t. |

| | |
|---|---|
| d. | If the system determines that the calculated |
| | percentage of amount is greater than the claim's |
| | original member pay amount (calculated percentage |
| | of amount > original member pay amount), then: |

| | |
|---|---|
| i. | The system defines the member pay amount to be |
| | included in the response to claims processing to |
| | be sum of the original member pay amount and |
| | the claim's plan sales tax (original member pay |
| | amount + claim's plan sales tax). |
| ii. | The system defines the plan pay amount to be |
| | included in the response to claims processing to |
| | be the remaining amount. |
| iii. | Resume basic flow at step 11.t. |

| | |
|---|---|
| e. | If the system determines that the sum of the |
| | calculated percentage of amount and the claim's plan |
| | sales tax is greater than the claim total cost |
| | ((calculated percentage of amount + claim's plan |
| | sales tax) > claim total cost), then: |

| | |
|---|---|
| i. | The system defines the member pay amount to be |
| | included in the response to claims processing to |
| | be the claim's plan sales tax. |
| ii. | The system defines the plan pay amount to be |
| | included in the response to claims processing to |
| | be the remaining amount. |
| iii. | Resume basic flow at step 11.t. |

| 11.o. | If the system determines that the claim outcome option is | |
|---|---|---|
| | the member pays the remainder after a percentage off of | |
| | the original member pay amount option, then: | |
| | a. | The system calculates the percentage off amount by |
| | | multiplying the original member pay amount by the |
| | | percentage off value defined in the event (original |
| | | member pay amount * percentage off value). |

| | |
|---|---|
| i. | If the percentage off amount calculation results in |
| | an amount with partial pennies, then the system |
| | rounds down the percentage off amount to the |
| | next cent. For example, if the original member pay |
| | amount is $201.21 and the percentage off value |
| | defined in the event is 10%, then the calculation |
| | result would be $181.089 (201.21 − (201.21 * .10); |
| | the system would round the result down to |
| | $181.08. |

| | |
|---|---|
| b. | If the system determines that the calculated |
| | percentage off amount is less than or equal to the |
| | claim total cost (calculated percentage off amount <= |
| | claim total cost), then: |

| | |
|---|---|
| i. | If the system determines that the calculated |
| | percentage off amount is less than or equal to the |
| | claim's original member pay amount (calculated |
| | percentage off amount <= original member pay |
| | amount), then: |

| | |
|---|---|
| 1. | The system defines the member pay amount to |
| | be included in the response to claims |
| | processing to be the original member pay |
| | amount less the calculated percentage off |
| | amount (original member pay amount − |
| | calculated percentage off amount). |
| 2. | The system defines the plan pay amount to be |
| | included in the response to claims processing |
| | to be the remaining amount. |
| 3. | Resume basic flow at step 11.t. |

| | |
|---|---|
| ii. | If the system determines that the calculated |
| | percentage off amount is greater than the claim's |
| | original member pay amount (calculated |
| | percentage off amount > original member pay |
| | amount), then: |

| | |
|---|---|
| 1. | The system defines the member pay amount to |
| | be included in the response to claims |
| | processing to be zero. |
| 2. | The system defines the plan pay amount to be |
| | included in the response to claims processing |
| | to be the claim total cost. |
| 3. | Resume basic flow at step 11.t. |

| | |
|---|---|
| c. | If the system determines that the calculated |
| | percentage off amount is greater than the claim total |
| | cost (calculated percentage off amount > claim total |
| | cost), then: |

| | |
|---|---|
| i. | The system defines the member pay amount to be |
| | included in the response to claims processing |
| | equal zero. |
| ii. | The system defines the plan pay amount to be |
| | included in the response to claims processing to |
| | be the claim total cost. |
| iii. | Resume basic flow at step 11.t. |

| 11.o. | If the system determines that the claim outcome option is | |
|---|---|---|
| | the member pays the remainder after a percentage off of | |
| | the original member pay amount plus sales tax option, | |
| | then: | |
| | a. | The system calculates the percentage off amount by |
| | | multiplying the original member pay amount by the |
| | | percentage off value defined in the event (original |
| | | member pay amount * percentage off value). |

| | |
|---|---|
| i. | If the percentage off amount calculation results in |
| | an amount with partial pennies, then the system |
| | rounds down the percentage off amount to the |
| | next cent. For example, if the original member pay |
| | amount is $201.21 and the percentage off value |
| | defined in the event is 10%, then the calculation |
| | result would be $181.089 (201.21 − (201.21 * .10); |
| | the system would round the result down to |
| | $181.08. |

| | |
|---|---|
| b. | If the system determines that the calculated |
| | percentage off amount and the claim's plan sales tax |
| | is less or equal to the claim total cost ((calculated |
| | percentage off amount + claim's plan sales tax) <= |
| | claim total cost), then: |

| | |
|---|---|
| i. | If the system determines that the calculated |
| | percentage off amount is less or equal to the |
| | claim's original member pay amount (calculated |
| | percentage off amount <= original member pay |
| | amount), then: |

| | |
|---|---|
| a. | The system defines the member pay amount to be |
| | included in the response to claims processing to be |
| | the original member pay amount less the difference of |
| | calculated percentage off amount and the claim's plan |
| | sales tax (original member pay amount − calculated |
| | percentage off amount) + claim's plan sales tax). |

| | |
|---|---|
| iii. | The system defines the plan pay amount to be |
| | included in the response to claims processing to |
| | be the remaining amount. |
| iv. | Resume basic flow at step 11.t. |

| | |
|---|---|
| c. | If the system determines that the calculated |
| | percentage off amount is greater than the claim's |
| | original member pay amount (calculated percentage |
| | off amount > original member pay amount), then: |

| | |
|---|---|
| i. | The system defines the member pay amount to be |
| | included in the response to claims processing to |
| | be the claim's plan sales tax. |
| ii. | The system defines the plan pay amount to be |
| | included in the response to claims processing to |
| | be the remaining amount. |
| iii. | Resume basic flow at step 11.t. |

| | |
|---|---|
| d. | If the system determines that the calculated |
| | percentage off amount is greater than the claim total |
| | cost (calculated percentage off amount > claim total |
| | cost), then: |

| | |
|---|---|
| i. | The system defines the member pay amount to be |
| | included in the response to claims processing to |
| | be the claim's plan sales tax. |
| ii. | The system defines the plan pay amount to be |
| | included in the response to claims processing to |
| | be the remaining amount. |
| iii. | Resume basic flow at step 11.t. |

| 11.p. | If the system determines that the flat dollar amount is | |
|---|---|---|
| | greater than the claim total cost (flat dollar amount > | |
| | claim total cost), then: | |
| | a. | The system defines the member pay amount to be |
| | | included in the response to claims processing to be |
| | | the original member pay amount. |
| | b. | The system defines the plan pay amount to be |
| | | included in the response to claims processing to be |
| | | the original plan pay amount. |
| | c. | Resume basic flow at step 11.t. |
| 11.q. | If the system determines that the flat dollar amount is | |
| | greater than the claim's original member pay amount (flat | |
| | dollar amount > original member pay amount), then: | |
| | a. | The system defines the member pay amount to be |
| | | included in the response to claims processing to be |
| | | the original member pay amount. |
| | b. | The system defines the plan pay amount to be |
| | | included in the response to claims processing to be |
| | | the original plan pay amount. |
| | c. | Resume basic flow at step 11.t. |
| 11.t. | If the system determines that the plan pay amount to be | |
| | included in the response to claims processing is greater | |
| | than the per claim plan max defined within the event (i.e. | |
| | plan pay is over the per claim maximum), then: | |
| | a. | The system defines the plan pay amount to be |
| | | included in the response to claim processing to be the |
| | | per claim plan max defined within the event. |
| | b. | The system defines the member pay amount to be |
| | | included in the response to claims processing to be |
| | | the claim total cost less the per claim plan max |
| | | defined within the event. |
| | c. | Resume basic flow at step 11.u. |
| 11.u. | If a free-form message has not been defined in the event, | |
| | then skip this step. Resume basic flow at step 11.v. | |
| 11.v. | If the claim being processed in EBM is a claim test or a | |
| | preliminary RAP claim, then skip this step. Resume basic | |
| | flow at step 11.ff. | |
| 11.v. | If a label for a member has not been defined in the event, | |
| | then skip this step. Resume basic flow at step 11.w. | |
| 11.w. | If a label for a claim has not been defined in the event, | |
| | then skip this step. Resume basic flow at step 11.x. | |
| 11.x. | If the claim being processed in EBM is a claim test or a | |
| | preliminary RAP claim, then skip this step. Resume basic | |
| | flow at step 11.ff. | |
| 11.x. | If the system determines that the event being processed | |
| | is an EBM member outcome exception, and then skip this | |
| | step. | |
| | a. | The system changes the member outcome exception |
| | | to a closed status. |
| | b. | Resume basic flow at step 11.ff. |
| 11.y. | If the claim being processed in EBM is a claim test or a | |
| | preliminary RAP claim, then skip this step. Resume basic | |
| | flow at step 11.ff. | |
| 11.y. | If the system determined that the values associated with | |
| | the claim do not match the accumulation rule set for the | |
| | event, then skip this step. Resume basic flow at step | |
| | 11.ff. | |
| 11.y. | If the system determines that there is not an open set and | |
| | not an orphaned set for accumulations for the member for | |
| | the event for the offer, then the system creates an open | |
| | set and increments the claim count accumulation by 1 for | |
| | the new open set for the member for the event for the | |
| | offer. Resume basic flow at step 11.z. | |
| 11.y. | If the system determines that there is an orphaned set for | |
| | accumulations for the member for the event for the offer, | |
| | then the system increments the claim count accumulation | |
| | in the orphaned set. Resume basic flow at step 11.z. | |
| 11.z. | If the system determines that there is an orphaned set for | |
| | accumulations for the member for the event for the offer, | |
| | then the system records the quantity accumulation in the | |
| | orphaned set. Resume basic flow at step 11.aa. | |
| 11.e. | If the event is not defined to calculate strength (i.e. does | |
| | not support accumulations for titration), then skip this | |
| | step. Resume basic flow at step 11.g. | |
| 11.f. | If the drug form on the claim does not = each, then skip | |
| | this step. Resume basic flow at step 11.g. | |
| 11.f. | If the strength unit is not provided, strength calculation | |
| | will not be performed, then skip this step. Resume basic | |
| | flow at step 11.g. | |
| 11. f. | If the strength unit is not G (grams), MG (milligrams), | |
| | MCG (micrograms), or ML (milliliters), strength calculation | |
| | will not be performed, then skip this step. Resume basic flow | |
| | at step 11.g. | |
| 11.f. | If the strength field on the claim contains multiple numeric | |
| | values for different units (for example, 85 mg/5 ml), then | |
| | skip this step. Resume basic flow at step 11.g. | |
| 11.aa. | If the system determines that there is an orphaned set for | |
| | accumulations for the member for the event for the offer, | |
| | then the system records the strength accumulation in the | |
| | orphaned set. Resume basic flow at step 11.bb. | |
| 11.bb. | If the system determines that there is an orphaned set for | |
| | accumulations for the member for the event for the offer, | |
| | then the system records the member pay amount | |
| | accumulation in the orphaned set. Resume basic flow at | |
| | step 11.cc | |
| 11.cc. | If the system determines that there is an orphaned set for | |
| | accumulations for the member for the event for the offer, | |
| | and then the system records the plan pay amount | |
| | accumulation in the orphaned set. Resume basic flow at | |
| | step 11.dd. | |
| 11.dd. | If the system determines that there is an orphaned set for | |
| | accumulations for the member for the event for the offer, | |
| | then the system records the max plan pay amount | |
| | accumulation in the orphaned set. Resume basic flow at | |
| | step 11.ee. | |
| 11.ee. | If the system determines that there is not an open set, | |
| | then skip this step and resume basic flow at step 11.ff. | |
| 11.ff. | If the system has processed all active events for the claim | |
| | (i.e. there are no more events to process), then: | |
| | a. | If the system has defined the member pay amount to |
| | | be included in the response to claims processing and |
| | | the plan pay amount to be included in the response to |
| | | claims processing, then resume basic flow at step 12. |
| | b. | If the system has not defined the member pay amount |
| | | to be included in the response to claims processing |
| | | and the plan pay amount to be included in the |
| | | response to claims processing, then: |

| | |
|---|---|
| i. | The system defines the member pay amount to be |
| | included in the response to claims processing to |
| | be the original member pay amount. |
| ii. | The system defines the plan pay amount to be |
| | included in the response to claims processing to |
| | the original plan pay amount. |
| iii. | The system does not set a free-form message to |
| | be included in the response to claims processing. |
| iv. | Resume basic flow at step 12. |

| 12. | The system determines that the member and plan pay | |
|---|---|---|
| | amounts that were recorded within each applicable | |
| | event's accumulations for this claim, require updates to | |
| | the member and/or plan pay amounts due to the values | |
| | changing by additional event processing. | |
| | a. | The system determines each event accumulations |
| | | that have been updated with this claim's information |
| | | during the processing of this claim. |
| | b. | The system replaces the previous member pay value |
| | | associated with this claim, with the new member pay |
| | | value for the claim for the member for the event for |
| | | the offer from the accumulation. |
| | c. | The system replaces the previous plan pay value |
| | | associated with this claim, with the new plan pay |
| | | value for the claim for the member for the event for |
| | | the offer from the accumulation. |
| | d. | The system replaces the previous max plan pay |
| | | accumulation that exists for the claim as it was first |
| | | processing, with the new max plan pay accumulation |
| | | value for the claim for the member for the event for |
| | | the offer. |

| | |
|---|---|
| 15. | If the system did not process the claim against a member |
| | outcome exception or Event, the system does not record |
| | a pre-EBM claim snapshot. |
| 16. | If the system did not process the claim against a member |
| | outcome exception or Event, the system does not record |
| | a post-EBM claim snapshot. |
| 19. | The claims processing system does not update the |
| | member pay amount on the claim, as the post EBM |
| | member pay amount is the same as the pre EBM |
| | member pay amount. |
| 20. | The claims processing system does not update the plan |
| | pay amount on the claim, as the post EBM plan pay |
| | amount is the same as the pre EBM plan pay amount. |
| 21. | The claims processing system does not add a free form |
| | message to the claim, as a free form message was not |
| | provided by EBM. |
| 23. | If the claim was not processed against a member |
| | outcome exception or Event, the system does not record |
| | a pharmacy claim snapshot. |

General business rules (BRs) are shown in Table 7 below.

TABLE 7
General Business Rules

| | |
|---|---|
| 1. | Processing and responding to claims processing for an EBM claim, |
| | must be before claims processing time out period for the EBM call |
| | out. |
| 2. | The EBM Processing System should be available during the same |
| | dates and times as the claims processing system. |
| 3. | There may not be an open set and an orphaned set for the member for |
| | the event for the offer at the same time. Only one of the two sets may |
| | exist at the same time. There may be multiple closed sets at any time. |
| 4. | The sum of the member pay amount and the plan pay amount re- |
| | turned in the response to claims processing must equal the claim |
| | total cost provided by claims processing when the claim was sent to |
| | EBM for EBM processing. |
| 5. | Only one member pay amount, plan pay amount, and, if applicable, |
| | free-form message are allowed to be returned in the response to |
| | claims processing. Multiple sets of amounts/messages are not |
| | allowed. |
| 6. | The ability to identify that a claim was processed against a member |
| | exception for a member, offer, configuration and event should be |
| | available to claims viewer and to add hoc queries. |

The business rules referenced in Tables 4 and 6 above are shown in Table 8 below.

TABLE 8
Referenced Business Rules

| 1. | An event shall be considered active if the claim's fill date is inclusively | |
|---|---|---|
| | between the event begin date and the event end date. | |
| 2. | There is an accumulation rule set, if there is at least one accumulation | |
| | rule. | |
| 3. | The associated claim or member values used to match the accumulation | |
| | rule set should be evaluated regardless of the case. For example, the | |
| | accumulation rule set includes brand name = zoloft. The claim record | |
| | could have a brand name of either Zoloft or zoloft or ZOLOFT in order for | |
| | there to be a match. | |
| 4. | There is an outcome rule set, if there is at least one outcome rule. | |
| 5. | The associated claim or member values used to match the outcome rule | |
| | set should be evaluated regardless of the case. For example, the | |
| | outcome rule set includes brand name = zoloft. The claim record could | |
| | have a brand name of either Zoloft or zoloft or ZOLOFT in order for there | |
| | to be a match. | |
| 6. | A claim or member may have multiple label names applied but each | |
| | label name applied must be unique. The same label may not be applied | |
| | more than once. For example, a member may have labels “under age | |
| | 65” and “male” (multiple label names); but may not have labels “under | |
| | age 65”, “under age 65” and “male” (second “under age 65” label not | |
| | unique). | |
| 7. | In an outcome rule set, outcome rules for claim count accumulations, | |
| | member pay accumulations, plan pay accumulations, strength | |
| | accumulations, and quantity accumulations are evaluated against the | |
| | open set for the member for the event for the offer. | |
| 8. | An EBM member outcome exception shall be considered active if the | |
| | claim's fill date is inclusively between the begin date and the end date of | |
| | the EBM member outcome exception. | |
| 9. | An EBM member outcome exception shall be considered open until it | |
| | has been processed and the associated claim has received the outcome | |
| | requested. | |
| 10. | There is a qualification rule set, if there is at least one rule. | |
| 11. | The associated claim or member values used to match the qualification | |
| | rule set should be evaluated regardless of the case. For example, the | |
| | qualification rule set includes brand name = zoloft. The claim record | |
| | could have a brand name of either Zoloft or zoloft or ZOLOFT in order for | |
| | there to be a match. | |
| 12. | The claims processing system determines that the claim should be | |
| | processed by EBM, by evaluating if EBM is enabled for the customer, | |
| | client and group on the claim and based on the claim fill date being | |
| | inclusively between the EBM begin date and the EBM end date. | |
| 13. | An offer association is when the submitted claim matches an existing | |
| | customer, client and group. | |
| 14. | When there is a match to multiple offers, the member's coverage code, | |
| | deductible id and dual coverage indicator are used to find the associated | |
| | offer. | |
| 15. | An active offer is an offer in which the process date is inclusively | |
| | between the begin date and end date of the offer. | |
| 16. | An active EBM configuration is a configuration in which the fill date on | |
| | the claim is inclusively between the EBM offer association start and end | |
| | dates. | |
| 17. | When member label name is selected as the criterion within an | |
| | accumulation, outcome or qualification rule set, the system would need | |
| | to evaluate all member label names associated with that member for a | |
| | match to the operator and value entered within the rule. | |
| 18. | If a Member Accumulation Exception has been saved for a member after | |
| | a claim has been processed for that member, but prior to the same claim | |
| | being adjusted, updated, reversed or deleted, the accumulation value or | |
| | values that were entered within the Exception are absolute values, and | |
| | will not be adjusted based on the adjusted, updated, reversed or deleted | |
| | claim. | |
| 19. | The system only calculates claim strength for claims that have a drug | |
| | form of each. | |
| 20. | The system calculates strength by taking the submitted unit within the | |
| | numeric strength value field from the claim and converts this unit to its | |
| | base unit. The system then takes the plan metric quantity times the | |
| | calculated base unit, which results in the strength calculation. Note: For | |
| | example, submitted claim's numeric strength value is 10 MG; the system | |
| | converts this unit to its base unit of .01 grams. The submitted claim's | |
| | plan metric quantity is 30. The system takes 30 × .01 = .3. .3 is the | |
| | strength calculation that will be added to the strength accumulation for | |
| | that member and that claim. | |
| | a. | If the strength unit is not provided, strength calculation will not be |
| | | performed. |
| | b. | If the strength unit is not G (grams), MG (milligrams), MCG |
| | | (micrograms), or ML (milliliters), strength calculation will not be |
| | | performed. |
| 21. | The system follows the following rules when calculating member and | |
| | plan pay amounts for EBM Event and EBM Member Outcome | |
| | Exceptions: | |
| | a. | The sales tax amount is included in the original plan pay amount. |
| | b. | The sum of the member pay amount and the plan pay amount |
| | | returned in the response to claims processing must equal the claim |
| | | total cost provided by claims processing when the claim was sent to |
| | | EBM for EBM processing. |
| | c. | If during an outcome calculation that does not include sales tax, the |
| | | member pay amount is calculated to be > the original member pay |
| | | amount, then the system defines the member pay amount to be |
| | | included in the response to claims processing to be the original |
| | | member pay amount. |
| | d. | If during an outcome calculation that does include sales tax, the |
| | | member pay amount is calculated to be > the original member pay |
| | | amount, then the system defines the member pay amount to be |
| | | included in the response to claims processing to be the original |
| | | member pay amount + the sales tax value. |
| | e. | The claim outcome option defined within an EBM Event or EBM |
| | | Member Outcome Exception represents an up to value. For |
| | | example, if the original member pay amount is $10 and the claim |
| | | outcome is member pays a flat amount of $15, then the system shall |
| | | calculate the member pay amount to be $10. Another example is if |
| | | the original member pay amount is $10 and the claim outcome is |
| | | member receives $20 Off, then the system shall calculate the |
| | | member pay amount to be $0. |
| | f. | If sales tax is selected as part of a claim outcome option, this amount |
| | | is added to the calculated member pay amount. |
| | g. | The calculated member pay amount + sales tax can be > the original |
| | | member pay amount. |

| 22. | The claim status numbers that EBM receives for the following status are: |
|---|---|
| | POS Paid = 10 and 11 |
| | Denied = 70 and 71 |
| | Adjust to Pay = 10 and 11 |
| | Adjust to Deny = 70 and 71 |
| | Reversed = 70 |
| | Deleted = 70 |

The illustrations of the embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “coupled with” is defined to mean directly connected to or indirectly connected through one or more intermediate components. Such intermediate components may include both hardware and/or software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

1. A computer-implemented method of processing a health insurance claim, the method comprising:
receiving, by a processor, a health insurance claim submitted to an insurance claims processing system by and/or on behalf of a consumer through a point of sale and/or a system coupled therewith;
identifying, by the processor, the health insurance claim as being eligible for rewards-based processing;
evaluating, by the processor, the health insurance claim in response to the receiving based on data associated with the consumer and/or the health insurance claim and/or the point of sale;
determining, by the processor, a dispositive outcome for the health insurance claim, wherein the dispositive outcome comprises rewarding the consumer for exhibiting a desired behavior; and
implementing, by the processor, the dispositive outcome at the point of sale;
wherein the consumer has a disease state, and wherein the desired behavior comprises monitoring the disease state.

2. The computer-implemented method of claim 1 wherein the processor is remote from the point of sale.

3. The computer-implemented method of claim 1 wherein the insurance claims processing system is operated by an insurance company and/or an affiliate thereof.

4. The computer-implemented method of claim 1 wherein the point of sale is located within a health care provider.

5. The computer-implemented method of claim 4 wherein the health care provider is selected from the group consisting of a pharmacy, a physician, a hospital, a clinic, a medical supply company, affiliates thereof, and combinations thereof.

6. The computer-implemented method of claim 1 further comprising receiving, by the processor, data provided by the consumer at the point of sale.

7. The computer-implemented method of claim 1 further comprising accessing, by the processor, data from a database coupled to the processor.

8. The computer-implemented method of claim 1 wherein the data are selected from the group consisting of internal information stored by and/or on behalf of the insurance claims processing system, external information provided at the point of sale, and a combination thereof.

9. The computer-implemented method of claim 8 wherein the internal information comprises information stored in an eligibility file.

10. The computer-implemented method of claim 8 wherein the internal information is selected from the group consisting of insurance claims history, demographics, consumer behavior, and combinations thereof.

11. The computer-implemented method of claim 8 wherein the external information is transmitted to the processor from the point of sale.

12. The computer-implemented method of claim 8 wherein the external information comprises evidence that the consumer has exhibited the desired behavior.

13. The computer-implemented method of claim 1 wherein the rewarding comprises reducing and/or waiving a co-pay.

14. The computer-implemented method of claim 1 wherein the dispositive outcome comprises adjusting a value of awards points credited to the consumer.

15. The computer-implemented method of claim 14 wherein the rewarding is deferred until the value of awards points meets or exceeds a threshold.

16. The computer-implemented method of claim 1 wherein the disease state is controllable through behavior modification.

17. The computer-implemented method of claim 1 wherein the disease state is selected from the group consisting of hypertension, diabetes, heart disease, high cholesterol, obesity, addictions, mental disorders, cancer, stroke, orthopedic injuries, dental problems, and combinations thereof.

18. The computer-implemented method of claim 1 wherein the monitoring comprises obtaining one or a plurality of measurements indicative of a status of the disease state.

19. The computer-implemented method of claim 18 wherein the desired behavior further comprises reporting the one or the plurality of the measurements to an entity selected from the group consisting of a health-care provider, an insurance company, an affiliate of the insurance company, and combinations thereof.

20. The computer-implemented method of claim 19 wherein the reporting comprises wired and/or wireless transmission of data over a network.

21. The computer-implemented method of claim 1 wherein the desired behavior further comprises performing the monitoring in accordance with a regular testing schedule.

22. The computer-implemented method of claim 1 wherein the disease state comprises diabetes, and wherein the monitoring comprises blood sugar testing.

23. The computer-implemented method of claim 1 wherein the dispositive outcome comprises tagging the insurance claim and/or the consumer according to a business rule.

24. The computer-implemented method of claim 23 wherein the business rule is selected from the group consisting of drug-related criteria, pharmacy-related criteria, prescriber-related criteria, consumer-related criteria, claim-related criteria, and combinations thereof.

25. The computer-implemented method of claim 1 wherein the dispositive outcome further comprises communicating with the consumer.

26. The computer-implemented method of claim 25 wherein the communicating comprises sending the consumer a communication selected from the group consisting of an electronic communication, a physical communication, and a combination thereof.

27. A system for processing a health insurance claim, the system comprising:
a processor;
a non-transitory memory coupled to the processor;
first logic stored in the memory and executable by the processor to cause the processor to receive a health insurance claim submitted to an insurance claims processing system by and/or on behalf of a consumer through a point of sale and/or a system coupled therewith;
second logic stored in the memory and executable by the processor to cause the processor to identify the health insurance claim as being eligible for rewards-based processing;
third logic stored in the memory and executable by the processor to cause the processor to evaluate the health insurance claim responsive to receipt thereof based on data associated with the consumer and/or the health insurance claim and/or the point of sale;
fourth logic stored in the memory and executable by the processor to cause the processor to determine a dispositive outcome for the health insurance claim, wherein the dispositive outcome comprises rewarding the consumer for exhibiting a desired behavior; and
fifth logic stored in the memory and executable by the processor to cause the processor to implement the dispositive outcome at the point of sale;
wherein the consumer has a disease state, and wherein the desired behavior comprises monitoring the disease state.

28. The system of claim 27 wherein the disease state is controllable through behavior modification.

29. The system of claim 27 wherein the disease state is selected from the group consisting of hypertension, diabetes, heart disease, high cholesterol, obesity, addictions, mental disorders, cancer, stroke, orthopedic injuries, dental problems, and combinations thereof.

30. The system of claim 27 wherein the monitoring comprises obtaining one or a plurality of measurements indicative of a status of the disease state.

31. The system of claim 30 wherein the desired behavior further comprises reporting the one or the plurality of the measurements to an entity selected from the group consisting of a health-care provider, an insurance company, an affiliate of the insurance company, and combinations thereof.

32. The system of claim 31 wherein the reporting comprises wired and/or wireless transmission of data over a network.

33. The system of claim 27 wherein the desired behavior further comprises performing the monitoring in accordance with a regular testing schedule.

34. The system of claim 27 wherein the disease state comprises diabetes, and wherein the monitoring comprises blood sugar testing.

35. A system for processing a health insurance claim, the system comprising:
means for receiving an insurance claim submitted to an insurance claims processing system by and/or on behalf of a consumer through a point of sale and/or a system coupled therewith;
means for identifying the health insurance claim as being eligible for rewards-based processing;
means for evaluating the health insurance claim responsive to receipt thereof based on data associated with the consumer and/or the health insurance claim and/or the point of sale;
means for determining a dispositive outcome for the health insurance claim, wherein the dispositive outcome comprises rewarding the consumer for exhibiting a desired behavior; and
means for implementing the dispositive outcome at the point of sale;
wherein the consumer has a disease state, and wherein the desired behavior comprises monitoring the disease state.

36. In a non-transitory computer readable storage medium having stored therein data representing instructions executable by a programmed processor for processing a health insurance claim, the storage medium comprising instructions for:
receiving a health insurance claim submitted to an insurance claims processing system by and/or on behalf of a consumer through a point of sale and/or a system coupled therewith;
identifying the health insurance claim as being eligible for rewards-based processing;
evaluating the health insurance claim in response to the receiving based on data associated with the consumer and/or the health insurance claim and/or the point of sale;
determining a dispositive outcome for the health insurance claim, wherein the dispositive outcome comprises rewarding the consumer for exhibiting a desired behavior; and
implementing the dispositive outcome at the point of sale;
wherein the consumer has a disease state, and wherein the desired behavior comprises monitoring the disease state.
